(19) United States
(12) Patent Application Publication
(10) Pub. No.: US 2025/0280399 A1
(43) Pub. Date: Sep. 4, 2025

(54) SIGNAL TRANSMISSION METHOD AND APPARATUS, AND COMMUNICATION DEVICE

(71) Applicant: VIVO MOBILE COMMUNICATION CO., LTD., Dongguan (CN)

(72) Inventors: Shengli DING, Dongguan (CN); Jianming WU, Dongguan (CN); Dajie JIANG, Dongguan (CN); Jian YAO, Dongguan (CN)

(21) Appl. No.: 19/212,608

(22) Filed: May 19, 2025

Related U.S. Application Data
(63) Continuation of application No. PCT/CN2023/132216, filed on Nov. 17, 2023.

(30) Foreign Application Priority Data
Nov. 24, 2022 (CN) 202211486055.9

(51) Int. Cl. H04W 72/0446; H04W 4/38; H04W 72/02; H04W 72/0453

(52) U.S. Cl. CPC H04W 72/0446; H04W 4/38; H04W 72/02; H04W 72/0453

(57) ABSTRACT

This application discloses a signal transmission method and apparatus, and a communication device. The signal transmission method in embodiments of this application includes: receiving, by a first device, parameter configuration information of a first signal, where the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain.

### CROSS-REFERENCE TO RELATED APPLICATIONS

This application is a continuation of International Patent Application No. PCT/CN2023/132216, filed on Nov. 17, 2023, which claims priority to Chinese Patent Application No. 202211486055.9, filed on Nov. 24, 2022, both of which are incorporated herein by reference in their entireties.

### TECHNICAL FIELD

This application pertains to the field of communication technologies, and specifically, relates to a signal transmission method and apparatus, and a communication device.

### BACKGROUND

A future mobile communication system, such as a B5G system or a 6G system, has a sensing capability in addition to a communication capability. One or more devices that have the sensing capability can sense information such as an orientation, a distance, and a speed of a target object by sending and receiving a wireless signal, or detect, track, identify, and image a target object, an event, an environment, and the like.

### SUMMARY

Embodiments of this application provide a signal transmission method and apparatus, and a communication device.

According to a first aspect, a signal transmission method is provided, including:
receiving, by a first device, parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a second aspect, a signal transmission method is provided, including: sending, by a second device, parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a third aspect, a signal transmission apparatus is provided, applied to a first device and including:
a first obtaining module, configured to receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a fourth aspect, a signal transmission apparatus is provided, applied to a second device and including:
a first transceiver module, configured to send parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a fifth aspect, a terminal (a first device) is provided. The terminal includes a processor and a memory. The memory stores a program or instructions capable of running on the processor, and the steps of the method according to the first aspect are implemented when the program or instructions are executed by the processor.

According to a sixth aspect, a terminal (a first device) is provided, including a processor and a communication interface, where the communication interface is configured to receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a seventh aspect, a network-side device (a first device or a second device) is provided. The network-side device includes a processor and a memory. The memory stores a program or instructions capable of running on the processor, and the steps of the method according to the first aspect or the second aspect are implemented when the program or the instructions are executed by the processor.

According to an eighth aspect, a network-side device (a first device or a second device) is provided, including a processor and a communication interface, where the communication interface is configured to receive or send parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

According to a ninth aspect, a signal transmission system is provided and includes a first device and a second device. The first device may be configured to perform the steps of the method according to the first aspect, and the second device may be configured to perform the steps of the method according to the third aspect.

According to a tenth aspect, a readable storage medium is provided. The readable storage medium stores a program or instructions, and the program or the instructions are executed by a processor to implement the steps of the method according to the first aspect or implement the steps of the method according to the second aspect.

According to an eleventh aspect, a chip is provided. The chip includes a processor and a communication interface. The communication interface is coupled to the processor, and the processor is configured to run a program or instructions to implement the method according to the first aspect or implement the method according to the second aspect.

According to a twelfth aspect, a computer program/program product is provided, where the computer program/program product is stored in a storage medium, and the computer program/program product is executed by at least one processor to implement the steps of the method according to the first aspect or the method according to the second aspect.

In embodiments of this application, a first device receives parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain.

### BRIEF DESCRIPTION OF DRAWINGS

FIG. 1 is a structural diagram of a communication system to which an embodiment of this application is applicable;

FIG. 2 is a schematic flowchart 1 of a signal transmission method according to an embodiment of this application;

FIG. 3 is a schematic resource diagram 1 of a first signal according to an embodiment of this application;

FIG. 4 is a schematic resource diagram 2 of a first signal according to an embodiment of this application;

FIG. 5 is a schematic resource diagram 3 of a first signal according to an embodiment of this application;

FIG. 6 is a schematic diagram 1 of a mapping relationship between a resource chunk and a resource set according to an embodiment of this application;

FIG. 7 is a schematic diagram 2 of a mapping relationship between a resource chunk and a resource set according to an embodiment of this application;

FIG. 8 is a schematic diagram 3 of a mapping relationship between a resource chunk and a resource set according to an embodiment of this application;

FIG. 9 is a schematic diagram of comparing resource overheads of using a chunk-wise uniform signal in this application and an existing equivalent uniformly distributed signal;

FIG. 10 is a schematic resource diagram 4 of a first signal according to an embodiment of this application;

FIG. 11 is a schematic resource diagram 5 of a first signal according to an embodiment of this application;

FIG. 12 is a schematic resource diagram 6 of a first signal according to an embodiment of this application;

FIG. 13 is a schematic resource diagram 1 of first signals of different ports according to an embodiment of this application;

FIG. 14 is a schematic resource diagram 2 of first signals of different ports according to an embodiment of this application;

FIG. 15 is a schematic resource diagram 3 of first signals of different ports according to an embodiment of this application;

FIG. 16 is a schematic resource diagram 7 of a first signal according to an embodiment of this application;

FIG. 17 is a schematic resource diagram 8 of a first signal according to an embodiment of this application;

FIG. 18 is a schematic resource diagram 9 of a first signal according to an embodiment of this application;

FIG. 19 is a schematic resource diagram 10 of a first signal according to an embodiment of this application;

FIG. 20 is a schematic resource diagram 11 of a first signal according to an embodiment of this application;

FIG. 21 is a schematic resource diagram 12 of a first signal according to an embodiment of this application;

FIG. 22 is a schematic flowchart 2 of a signal transmission method according to an embodiment of this application;

FIG. 23 is a schematic flowchart 3 of a signal transmission method according to an embodiment of this application;

FIG. 24 is a schematic module diagram 1 of a signal transmission apparatus according to an embodiment of this application;

FIG. 25 is a schematic module diagram 2 of a signal transmission apparatus according to an embodiment of this application;

FIG. 26 is a structural block diagram of a communication device according to an embodiment of this application;

FIG. 27 is a structural block diagram of a terminal according to an embodiment of this application;

FIG. 28 is a structural block diagram 1 of a network-side device according to an embodiment of this application; and

FIG. 29 is a structural block diagram 2 of a network-side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. The following describes a new radio (NR) system for illustrative purposes, and NR terms are used in most of the following descriptions. However, these technologies are also applicable to applications such as a 6th generation (6G) communication system other than NR system applications.

In an integrated sensing and communication scenario, the following problem exists in conventional uniformly distributed sensing signal resource configuration: to meet a sensing requirement (such as a resolution or a maximum unambiguous measurement range), relatively high resource overheads of a sensing signal are required.

Embodiments of this application provide a signal transmission method and apparatus, and a communication device, so as to resolve a problem that relatively high resource overheads of a sensing signal are required to meet a sensing requirement in an integrated sensing and communication scenario. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

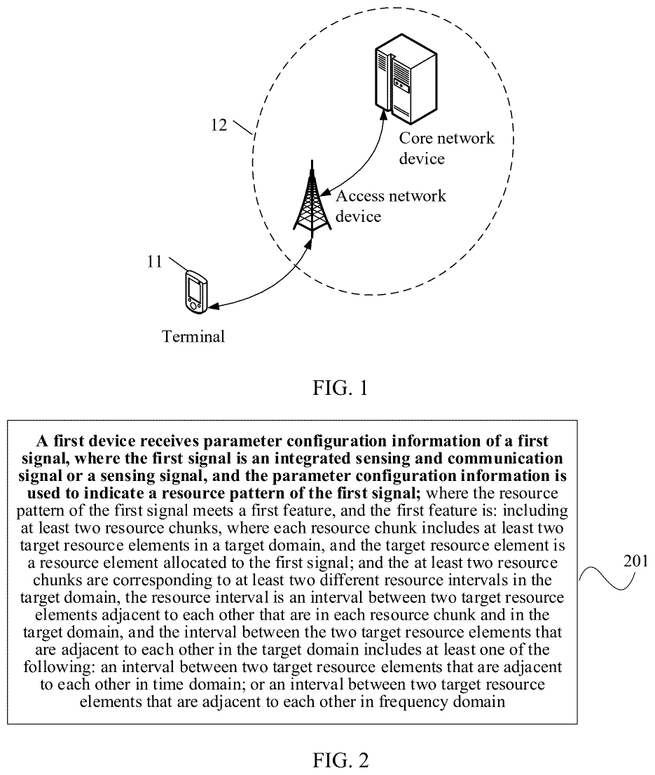

FIG. 1 is a block diagram of a wireless communication system applicable to an embodiment of this application. The wireless communication system includes a terminal 11 and a network-side device 12. The terminal 11 may be a mobile phone, a tablet personal computer (Tablet Personal Computer), a laptop computer (Laptop Computer) or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device (Wearable Device), vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. Provided that the same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), or the like. It should be noted that in the embodiments of this application, only a core network device in the NR system is used as an example for description, and a specific type of the core network device is not limited.

To enable a person skilled in the art to better understand embodiments of this application, the following description is first provided.

### I. Integrated Sensing and Communication

In the future, B5G and 6G wireless communication systems are expected to provide various high-precision sensing services, such as indoor positioning of robot navigation, Wi-Fi sensing of smart homes, and radar sensing of self-driving vehicles. Sensing and communication systems are usually designed separately and occupy different frequency bands. Then, because of widespread deployment of millimeter wave and large-scale multiple input multiple output (MIMO) technologies, a communication signal in a future wireless communication system often has a high resolution in both time domain and angle domain, which makes it possible to implement high-precision sensing by using the communication signal. Therefore, it is preferable to jointly design sensing and communication systems so that they can share a same frequency band and hardware to improve frequency efficiency and reduce hardware costs. This facilitates study of integrated sensing and communication (ISAC). ISAC will become a key technology in a future wireless communication system to support many important application scenarios. For example, in a future self-driving vehicle network, a self-driving vehicle will obtain a large amount of information from a network, including an ultra-high-resolution map and near-real-time information, to implement navigation and avoid an impending traffic jam. In a same case, a radar sensor in the self-driving vehicle should be capable of providing a powerful, high-resolution obstacle detection function with a resolution in centimeters. The ISAC technology used for the self-driving vehicle provides a possibility of implementing high data rate communication and high resolution obstacle detection by using same hardware and spectrum resources. Other applications of ISAC include Wi-Fi-based indoor positioning and activity identification, communication and sensing of an unmanned aircraft, extended reality (XR), radar and communication integration, and the like. Each application has different requirements, restrictions, and regulatory problems. ISAC has attracted great interest and attention from academia and industry. For example, more and more academic publications on ISAC have been published recently, ranging from transceiver frame design, ISAC waveform design, joint coding design, time-frequency-spatial signal processing to experimental performance delay, prototype design, and field testing.

ISAC achieves integrated low-cost implementation of communication and sensing functions in a manner of hardware device sharing and a software definition function. Characteristics mainly include: a unified and simplified architecture, a reconfigurable and scalable function, and improved efficiency and reduced costs. Advantages of integrated sensing and communication mainly include three aspects: reduced device costs and sizes, improved spectrum utilization, and improved system performance.

Academia generally divides development of ISAC into four stages: coexistence, co-operation, co-design, and co-collaboration.

Coexistence: Communication and sensing are two systems that are separated from each other. The two systems interfere with each other. Main methods to solve interference are distance isolation, frequency band isolation, time division-based work, MIMO technology, precoding, and the like.

Co-operation: Communication and sensing share a hardware platform, and improve common performance by using common information. Power allocation between the two greatly affects system performance. Main problems are: a low signal-to-noise ratio, mutual interference, and a low throughput.

Co-design: Communication and sensing become a complete joint system, including joint signal design, waveform design, code design, and the like. In an earlier period, there are a linear frequency modulation waveform, a spread spectrum waveform, and the like, and then a focus is on an orthogonal frequency division multiplexing (OFDM) waveform, a MIMO technology, and the like.

Co-collaboration: A plurality of integrated sensing and communication nodes cooperate with each other to implement a common objective. For example, radar detection information is shared through communication data transmission. Typical scenarios include a driving assistance system, radar assistance communication, and the like.

Currently, a typical integrated sensing and communication scenario that is expected to be implemented by performing a technical upgrade according to a 5G communication system architecture is shown in Table 1.

TABLE 1

| Wireless sensing | Sensing | Application |
|---|---|---|
| category | function | scenario |
| Large-scale macro | Weather, air quality, and the like | Meteorology, agriculture, and |
| sensing type | | life services |
| | Traffic flow (intersections) and | Smart city, smart transportation, |
| | crowd flow (subway entrances) | and commercial services |
| | Animal activity and migration, and | Animal husbandry, ecological |
| | the like | environment protection, and the |
| | | like |
| | Target tracking, distance | Many application scenarios of a |
| | measurement, speed measurement, | conventional radar |
| | outlining, and the like | |
| | Three-dimensional map | Intelligent driving, navigation, |
| | construction | smart city |
| Short-range granular | Action and posture recognition | Smart interaction of |
| sensing class | | smartphones, gaming, and smart |
| | | home |
| | Heartbeat, breathing, and the like | Health and medical care |
| | Imaging, material detection, and | Security inspection, industry, and |
| | the like | the like |

### II. Radar Technology

A radar means “radio detection and ranging”, that is, a target is discovered and a target distance is measured by transmitting a radio wave and receiving an echo reflected by the target. With development of the radar technology, a radar detection objective is not only to measure a distance from a target, but also to measure a speed, an azimuth angle, and a pitch angle of the target, and extract more information about the target, including a size and a shape of the target, from the foregoing information.

The radar technology was originally used for military purposes to detect targets such as an aircraft, a missile, a vehicle, a naval vessel, and the like. With development of technology and social evolution, the radar is increasingly used in civil scenarios. A typical application is that a weather radar measures information such as a location and an intensity of cloud and rain by measuring an echo from a weather target such as cloud and rain. Further, with flourishing development of electronic information industry, Internet of Things, communication technology, and the like, the radar technology starts to enter a daily life application of people, which greatly improves convenience and safety of work and life. For example, a vehicle radar provides warning information for driving of a vehicle by measuring a distance and a relative speed between vehicles, between a vehicle and a surrounding environment object, and between a vehicle and a pedestrian, thereby greatly improving a road traffic safety level.

At a technical level, the radar has many classification manners. According to a location relationship between radar receiving and sending stations, radars can be divided into a monostatic radar and a bistatic radar. For the monostatic radar, a signal transmitter is integrated with a receiver and they share an antenna. Advantages are that a target echo signal is naturally coherent with a local oscillator of the receiver, and signal processing is convenient. Disadvantages are that signal receiving and transmitting cannot be performed at the same time, and only a signal waveform with a specific duty ratio can be used, thus bringing about a detection blind zone, which needs to be remedied by using a complex algorithm. Alternatively, signal transmitting and receiving are simultaneously performed, and strict isolation between transmitting and receiving is performed. However, it is difficult for a high-power military radar to achieve that. For the bistatic radar, a signal transmitter and receiver are located at different locations. Advantages are that signal transmitting and receiving can be simultaneously performed, and a continuous waveform can be used for detection. Disadvantages are that it is difficult to implement co-frequency and coherence between the receiver and the transmitter, and signal processing is relatively complex.

In a wireless sensing application of integrated sensing and communication, the radar technology may use a monostatic radar mode or a bistatic radar mode.

In the monostatic radar mode, signal receiving and transmitting share an antenna, and a receive signal and a transmit signal enter different radio frequency processing links by using a circulator. In this mode, a continuous wave signal waveform may be used to implement detection without a blind zone, provided that the receive signal and the transmit signal need to be well separated from each other. Generally, an isolation degree of about 100 dB is required, so as to eliminate inundation on the receive signal by leakage of the transmit signal. Because a receiver of the monostatic radar has all information of the transmit signal, signal processing may be performed in a manner of matched filtering (pulse compression) to obtain a relatively high signal processing gain.

In the bistatic radar mode, there is no isolation problem of signal transmitting and receiving, which greatly simplifies hardware complexity. Because radar signal processing is based on known information, in a 5G NR integrated sensing and communication application, known information such as a synchronization signal (primary synchronization signal (PSS)/secondary synchronization signal (SSS)) and a reference signal (DMRS)/channel state information-reference signal (CSI-RS)) may be used to perform radar signal processing. However, because of a periodicity of the synchronization signal, the reference signal, and the like, an ambiguity pattern of a signal waveform is no longer a thumbtack shape, but a bed-of-nails shape. A degree of ambiguity of a delay and Doppler increases, a gain of a main lobe is much lower than that in the monostatic radar mode, and measurement ranges of a distance and a speed are reduced. With proper parameter set design, the measurement ranges of the distance and the speed can meet measurement requirements of common targets such as automobiles and pedestrians. In addition, a measurement precision of the bistatic radar is related to a location of a transceiver station relative to a target, and a proper pair of transceiver stations needs to be selected to improve detection performance.

### III. Conventional Uniformly Distributed Sensing Signals

To investigate a requirement for resource configuration of a sensing signal under a given sensing requirement,
the sensing requirement includes a requirement for a resolution and/or a maximum unambiguous measurement range of a target parameter. The target parameters include a delay or a distance, Doppler or a speed, and an angle.

A resource is a resource in a target domain corresponding to the target parameter. The target domain and the resource in the target domain include:
1. time domain: a time resource, including an orthogonal frequency division multiplexing (OFDM) symbol, a slot, a subframe, a frame, and the like;
2. frequency domain: a frequency resource, including a subcarrier, a resource block (RB), and the like; and
3. space domain: an antenna or a port resource.

The requirements of the sensing requirement on resource configuration mainly include two aspects:
1. Resource span: In a target domain, a span between a minimum resource element index and a maximum resource element index of a resource of a sensing frame includes a time length (time domain), a bandwidth (frequency domain), and an aperture (space dimension).
2. Resource element interval: In a target domain, an interval between target resource elements that are in a sensing frame and adjacent to each other in the target domain includes an interval between OFDM symbols allocated to a sensing signal (time domain), a spacing between subcarriers allocated to the sensing signal (frequency domain), and an interval between antennas or ports allocated to the sensing signal (space domain).

Impact of resource configuration on sensing includes:
1. A resource span determines a resolution of a target parameter, including: A time span in time domain determines a measurement resolution of Doppler or a speed, a bandwidth in frequency domain determines a measurement resolution of a delay or a distance, and an aperture in space domain determines a measurement resolution of an angle.
2. A target resource element interval determines a maximum unambiguous measurement range of a target parameter, including: An interval between OFDM symbols allocated to a sensing signal in time domain determines a maximum unambiguous measurement range of Doppler or a speed, a spacing between subcarriers allocated to the sensing signal in frequency domain determines a maximum unambiguous measurement range of a delay or a distance, and an interval between antennas or ports allocated to the sensing signal in space domain determines a maximum unambiguous measurement range of an angle.

The following discusses a relationship between resource configuration of a sensing signal and a sensing requirement by focusing on resource configuration in time domain and frequency domain.

### 1. Delay/Distance

When sensing is performed by using an electromagnetic wave, delay information is directly obtained, and a distance is obtained through conversion of the delay. Therefore, a relationship between the delay and resource configuration of the sensing signal is mainly discussed herein.

A resolution of the delay is given in the following formula:

$$Δτ = \frac{1}{B} ;$$

where B represents a signal bandwidth.

A maximum unambiguous measurement range of the delay is given in the following formula:

$${τ}_{max} = \frac{1}{Δ f} ,$$

where Δf is a spacing between adjacent subcarriers allocated to the sensing signal.

### 2. Doppler/Speed

Doppler information is directly obtained when sensing is performed by using an electromagnetic wave, and a speed is obtained through conversion of Doppler. Therefore, a relationship between Doppler and resource configuration of the sensing signal is mainly discussed herein.

A resolution of Doppler is given in the following formula:

$$Δ {f}_{d} = \frac{1}{T} ;$$

where T is a time length of a sensing frame.

A maximum unambiguous measurement range of Doppler is given in the following formula:

$${f}_{d , max} = \frac{1}{Δ t} ;$$

where Δt indicates an interval between adjacent OFDM symbols allocated to the sensing signal.

According to the foregoing analysis, when the resolutions and the maximum unambiguous measurement ranges that are of the delay and the Doppler in the sensing requirement are given, that is, Δτ, τₘₐₓ, Δf_{d}, and f_{d,max} are given. Then, a number of required sensing resources is:

### 1. Number of Subcarriers

$${N}_{scs} = \frac{B}{Δ f} = \frac{{τ}_{max}}{Δτ} ;$$

### Number of OFDM Symbols

$${N}_{symbol} = \frac{T}{Δ t} = \frac{{f}_{d , max}}{Δ {f}_{d}} ;$$

The following describes, with reference to a typical scenario, a requirement of a sensing signal on a sensing resource (a subcarrier and an OFDM symbol). Considering a traffic monitoring scenario:

A maximum unambiguous distance measurement range is 200 m;
a distance measurement resolution is 0.2 m;
a speed measurement range is −180 km/h to 180 km/h (an overspeeding vehicle can be detected, including two directions “close to” and “away from”); and
a speed measurement resolution is 0.2 m/s.

Considering a millimeter wave frequency band whose carrier center frequency is 30 GHz, a corresponding configuration requirement of a sensing resource meets the following conditions:
bandwidth B≥750 MHz;
spacing Δf≤1500 kHz between adjacent subcarriers allocated to a sensing signal;
time length T≥25 ms of a sensing frame; and
interval Δt≤50 μs between adjacent OFDM symbols allocated to the sensing signal.

Based on the foregoing analysis, in the traffic monitoring scenario provided herein, a number of required sensing resources is:
number of subcarriers N_{scs}≥500; and
number of OFDM symbols N_{symbol}≥500.

It may be learned that, to meet the sensing requirement of the foregoing traffic monitoring scenario, overheads of time domain and frequency domain resources are relatively high. Further, a proportion of the foregoing time-frequency domain resource overheads in the entire time-frequency domain is examined. In a case of a center frequency with 30 GHz, if a subcarrier spacing is considered as 120 kHz, a time length of an OFDM symbol is 8.33 μs. To meet the foregoing resource configuration requirement, 1 subcarrier of every 12 subcarriers needs to be allocated to the sensing signal, and 1 OFDM symbol of every 6 OFDM symbols needs to be allocated to the sensing signal. In a multi-port sensing scenario, an overhead ratio of a sensing resource is further increased.

In an integrated sensing and communication scenario, the following three problems exist in conventional uniformly distributed sensing signal resource configuration:

First, to meet a sensing requirement (resolution and maximum unambiguous measurement range), relatively high resource overheads of a sensing signal are required.

Second, in a communication system, because various communication reference signals (for example, a CSI-RS, a demodulation reference signal (DMRS), and a phase-tracking reference signal (PTRS)) occupy a large number of time-frequency domain grids, in many cases, uniformly distributed time-frequency domain resource grids of a continuous large span (large bandwidth and large time-width) cannot be found in time-frequency domain to meet the sensing requirement.

Third, how to perform sensing with reference to various existing communication reference signals, so as to reduce overheads of a time-frequency domain resource of the sensing signal.

With reference to the accompanying drawings, the following describes in detail the signal transmission method provided in embodiments of this application by using some embodiments and application scenarios thereof.

As shown in FIG. 2, an embodiment of this application provides a signal transmission method, including:

Step 201: A first device receives parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

Optionally, each resource chunk is corresponding to one resource interval in the target domain, that is, each resource chunk has only one resource interval in the target domain. However, resource intervals corresponding to resource chunks in the target domain may be the same or different, and the at least two resource chunks have at least two different resource intervals in the target domain.

In this step, the first device obtains the parameter configuration information of the first signal sent by a second device, where the first device includes but is not limited to a terminal or a base station, and the second device includes but is not limited to a base station or a core network device.

The resource element includes at least one of a time domain resource element or a frequency domain resource element, the time domain resource element includes but is not limited to an OFDM symbol, and the frequency domain resource element includes but is not limited to a subcarrier. That is, the target resource element may be at least one of a target OFDM symbol or a target subcarrier.

It should be noted that, in the target domain, one or more resource elements that are not allocated to the first signal may exist between two adjacent target resource elements. When an interval between the target resource elements is calculated, a number of resource elements that are not allocated to the first signal should be included. For example, if the 0th and the 7th OFDM symbols in each slot (14 symbols are numbered 0 to 13) are allocated to the first signal, the 0th and the 7th OFDM symbols herein are the target resource elements, and an interval between the target resource elements is duration of 7 OFDM symbols. For another example, if the 0th and the 6th subcarriers in each RB (12 subcarriers are numbered 0 to 11) are allocated to the first signal, the 0th and the 6th subcarriers herein are the target resource elements, and an interval between the target resource elements is a bandwidth corresponding to 6 subcarriers.

In embodiments of this application, a first device receives parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

Optionally, in a case that the target domain includes time domain, the at least two resource chunks include M time domain resource chunks, M≥2, and M is a positive integer;
in a case that the target domain includes frequency domain, the at least two resource chunks include N frequency domain resource chunks, N≥2, and N is a positive integer; and
in a case that the target domain includes time domain and frequency domain, the at least two resource chunks include M×N time-frequency domain resource chunks, and the M×N time-frequency domain resource chunks are determined according to M time domain resource chunks and N frequency domain resource chunks.

In an embodiment of this application, the target domain includes time domain, the at least two resource chunks include M time domain resource chunks, the target resource element is a target OFDM symbol, the resource interval is an interval between two adjacent target OFDM symbols, and the interval may be described as a target OFDM symbol interval. Target OFDM symbols in each resource chunk are distributed at equal intervals.

In an embodiment of this application, the target domain includes frequency domain, the at least two resource chunks include N frequency domain resource chunks, the target resource element is a target subcarrier, and the resource interval is a spacing between two adjacent target subcarriers. The spacing may be described as a target subcarrier spacing, and target subcarriers in each resource chunk are distributed at equal spacings.

Optionally, the at least two resource chunks meet at least one of the following:

Item 1: The at least two target resource elements that are in each resource chunk and in the target domain are uniformly distributed in the target domain, that is, two adjacent target resource elements in each resource chunk have a same interval in the target domain.

Item 2: A resource span of the at least two resource chunks in the target domain meets a resolution requirement of a sensing measurement amount corresponding to the target domain.

Item 3: A resource interval of at least one resource chunk in the target domain meets a maximum unambiguous measurement range requirement of the sensing measurement amount corresponding to the target domain;
where the resource span is a span between the first target resource element and the last target resource element of the at least two resource chunks in the target domain, and the sensing measurement amount corresponding to the target domain includes Doppler, speed, delay, or distance.

For Item 1, “uniform distribution” in a strict sense means that resource intervals between adjacent target resource elements in the target domain are the same. For example, if the target resource element is a target OFDM symbol, time intervals between adjacent target OFDM symbols are equal. However, because a cyclic prefix (CP) of the first OFDM symbol of each 0.5 ms in an NR signal is longer than a CP of another OFDM symbol, if a case of mixing the first OFDM symbol of each 0.5 ms with another OFDM symbol is considered, time intervals between OFDM symbols are not uniformly distributed. According to a simulation situation, in an existing NR protocol, a CP of the first OFDM symbol of each 0.5 ms is longer than a CP of another OFDM symbol, and an extra error caused by this phenomenon to a measurement result of Doppler or a speed is very small and may be ignored. Therefore, “uniform distribution” in a loose sense means that a number of OFDM symbols included between adjacent target OFDM symbols is equal. In a case that at most one OFDM symbol in each 0.5 ms is a target OFDM symbol, “uniform distribution” in a loose sense is equivalent to “uniform distribution” in a strict sense, for example, a case that the 1st OFDM symbol of 0.5 ms is a target OFDM symbol, or the 1st OFDM symbol of each 1 ms is a target OFDM symbol.

“Uniform distribution” in embodiments of this application includes the foregoing “uniform distribution” in a strict sense and “uniform distribution” in a loose sense.

For Item 2, in a case that the target domain is time domain, the sensing measurement amount corresponding to time domain includes Doppler or a speed. In a case that the target domain is frequency domain, the sensing measurement amount corresponding to frequency domain includes a delay or a distance.

Optionally, the target domain includes time domain, and a resource span of the at least two resource chunks in time domain meets a resolution requirement of the Doppler or the speed.

The resource span of the at least two resource chunks in time domain specifically refers to total duration corresponding to resources between a target OFDM symbol of a minimum index and a target OFDM symbol of a maximum index in time domain, and the total duration includes a time length occupied by an OFDM symbol that is not allocated to the first signal and that is located between the target OFDM symbol of the minimum index and the target OFDM symbol of the maximum index in time domain. Assuming that the total duration is T (generally referred to as a sensing frame length, or coherence processing time, indicating a length in time domain of a first signal for which one-time coherent signal processing is performed, a sensing measurement amount is obtained, or a sensing result is obtained), T meets the following formula: T≥1/Δf_{d} or T≥c/2f_{c}Δv, where Δf_{d} indicates a Doppler resolution in the sensing requirement, c indicates a speed of light, f_{c} indicates a carrier center frequency, and Δv indicates a speed resolution in the sensing requirement.

Herein, the resource span of the at least two resource chunks in time domain meets a resolution requirement of the Doppler or the speed, so that resource overheads can be reduced while the first signal meets sensing resolution performance.

Optionally, the target domain includes frequency domain, and a resource span of the at least two resource chunks in frequency domain meets a resolution requirement of the delay or the distance.

The resource span of the at least two resource chunks in frequency domain is a total bandwidth between a target subcarrier of a minimum index and a target subcarrier of a maximum index in frequency domain, which includes a bandwidth occupied by a subcarrier that is not allocated to the first signal and that is located between the target subcarrier of the minimum index and the target subcarrier of the maximum index in frequency domain. Assuming that the total bandwidth is B, B meets the following formula: B>1/Δτ or B≥c/2ΔR, where Δτ indicates a delay resolution in the sensing requirement, c indicates a speed of light, and ΔR indicates a distance resolution in the sensing requirement.

Herein, the resource span of the at least two resource chunks in frequency domain meets a resolution requirement of the delay or the distance, so that resource overheads can be reduced while the first signal meets sensing resolution performance.

For Item 3, optionally, in a case that the target domain is time domain, a corresponding sensing measurement amount includes Doppler or a speed. In a case that the target domain is frequency domain, a corresponding sensing measurement amount includes a delay or a distance.

Optionally, the target domain includes time domain, and a resource interval of the at least one resource chunk in time domain meets a maximum unambiguous measurement range requirement of the Doppler or the speed.

In an embodiment of this application, it is assumed that a resource chunk, in time domain, whose resource interval meets a maximum unambiguous measurement range requirement of the Doppler or the speed is a first time domain chunk. It should be noted that “first” herein does not represent a sequence relationship in any sense, and is merely an indication given for convenience of description. A target OFDM symbol interval ΔT of the first signal in the first time domain chunk meets: ΔT≤1/f_{d,max} or ΔT≤c/2f_{c}vₘₐₓ, where f_{d,max} indicates a maximum unambiguous measurement value of the Doppler, c indicates a speed of light, f_{c} indicates a carrier center frequency, and vₘₐₓ indicates a maximum unambiguous measurement value of the speed.

The maximum unambiguous measurement value of the Doppler or the maximum unambiguous measurement value of the speed is determined according to the sensing requirement or sensing prior information, and includes one of the following:

When a direction of the Doppler or the speed is known, a relationship between the maximum unambiguous measurement value of the Doppler or the speed and a maximum Doppler value f_{d,max}⁰ or a maximum speed value vₘₐₓ⁰ of the target in the sensing prior information or the sensing requirement is: f_{d,max}=|f_{d,max}⁰| or vₘₐₓ=|vₘₐₓ⁰|; or
when a direction of the Doppler or the speed is unknown, a relationship between the maximum unambiguous measurement value of the Doppler or the speed and a maximum Doppler value f_{d,max}⁰ or a maximum speed value vₘₐₓ⁰ of the target in the sensing prior information or the sensing requirement is: f_{d,max}=2|f_{d,max}⁰| or vₘₐₓ=2|vₘₐₓ⁰|.

Optionally, duration occupied by the first time domain chunk is greater than a maximum value of the resource interval, that is, the duration T₁ occupied by the first time domain chunk is greater than a maximum value ΔTₘₐₓ of all target OFDM symbol interval values.

Herein, the resource interval of at least one resource chunk in time domain meets the maximum unambiguous measurement range requirement of the Doppler or the speed, so that resource overheads can be reduced while the first signal meets maximum unambiguous measurement range performance of sensing.

Optionally, the target domain includes frequency domain, and a resource interval of the at least one resource chunk in frequency domain meets a maximum unambiguous measurement range requirement of the delay or the distance.

In an embodiment of this application, it is assumed that a resource chunk, in frequency domain, whose resource interval meets a maximum unambiguous measurement range requirement of the delay or the distance is a first frequency domain chunk. It should be noted that “first” herein does not represent a sequence relationship in any sense, and is merely an indication given for convenience of description. A target subcarrier spacing Δf of the first signal in the first frequency domain chunk meets: Δf≤1/τₘₐₓ or Δf≤c/2Rₘₐₓ, where τₘₐₓ indicates a maximum unambiguous measurement value of the delay, c indicates a speed of light, and Rₘₐₓ indicates a maximum unambiguous measurement value of the distance.

Optionally, a bandwidth occupied by the first frequency domain chunk is greater than a maximum value of the resource interval, and the bandwidth B₁ occupied by the first frequency domain chunk is greater than a maximum value Δfₘₐₓ of all target subcarrier spacing values.

Herein, the resource interval of at least one resource chunk in frequency domain meets the maximum unambiguous measurement range requirement of the delay or the distance, so that resource overheads can be reduced while the first signal meets maximum unambiguous measurement range performance of sensing.

The parameter configuration information of the first signal in this embodiment of this application may also be described as chunk-wise uniform signal configuration information, that is, chunk-wise uniform signal configuration is performed on the first signal.

The following describes resource configuration of the first signal in detail with reference to a specific embodiment.

In an embodiment of this application, the first signal uses chunk-wise uniform signal configuration in time domain described in this application. In this configuration, distribution of the first signal in time domain, that is, distribution of OFDM symbols allocated to the first signal, uses the solution described in this application. Specifically, a location of an OFDM symbol allocated to the first signal in time domain is described by using: a system frame number n_{f}, a half frame number, a subframe number, a slot number nₛ^{μ} or n_{s,f}^{μ}, and an OFDM symbol number l in a slot.

A distribution situation of the first signal in frequency domain is not limited herein. In some embodiments, subcarriers assigned to the first signal are arranged in conventional uniform distribution (namely, comb distribution) in frequency domain, for example, a kth subcarrier in each RB in a bandwidth part (BWP) in which the first signal is located is assigned to the first signal, where k is a subcarrier number in the RB.

The first signal has the following features in time domain:

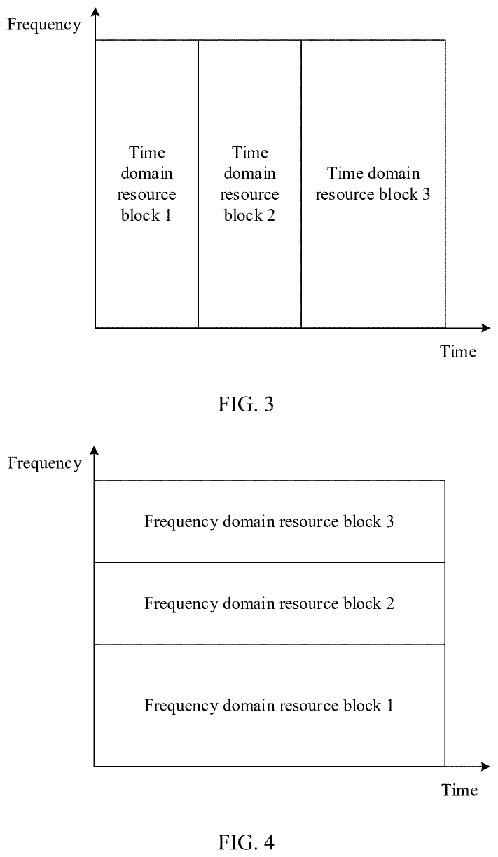

Feature T1: Including at least two time domain resource chunks, as shown in FIG. 3, including 3 time domain resource chunks;

Feature T2: In each time domain resource chunk, target OFDM symbols allocated to the first signal are uniformly distributed (hereinafter, “OFDM symbols allocated to the first signal” are referred to as “target OFDM symbols”), that is, the target OFDM symbols are distributed at equal intervals in time domain, and an interval between the target OFDM symbols is referred to as a target OFDM symbol interval;

Feature T3: The at least two time domain resource chunks have at least two different target OFDM symbol intervals; and

Feature T4: Total duration occupied by all target OFDM symbols allocated to the first signal meets the resolution requirement of the Doppler or the speed.

The total duration is total duration corresponding to resources between a target OFDM symbol of a minimum index and a target OFDM symbol of a maximum index in time domain.

Feature T5: In at least one time domain resource chunk of the at least two time domain resource chunks, a target OFDM symbol interval meets the maximum unambiguous measurement range requirement of the Doppler or the speed.

Optionally, in addition to the foregoing features in time domain, the first signal should further meet a condition: Duration T₁ occupied by the first time domain chunk is greater than a maximum value ΔTₘₐₓ of all target OFDM symbol interval values, and the first time domain chunk is a time domain resource chunk meeting Feature T5.

In an embodiment of this application, the first signal uses chunk-wise uniform signal configuration in frequency domain described in this application. In this configuration, distribution of the first signal in frequency domain, that is, distribution of subcarriers allocated to the first signal, uses the solution described in this application. It should be emphasized that configuration of the first signal in an activated BWP is considered herein. A distribution situation of the first signal in time domain is not limited herein. In some embodiments, OFDM symbols assigned to the first signal are arranged in conventional uniform distribution in time domain. For example, in a slot meeting (Nₛₗₒₜ^{frame,μ}n_{f}+n_{s,f}^{μ}−T_{offset})mod T_{CSI-RS}=0, and l₀th and/or an l₁th OFDM symbols are allocated to the first signal, where Nₛₗₒₜ^{frame,μ} is a slot count included in one system frame, n_{f} is a system frame number, n_{s,f}^{μ} is a slot number in a system frame, T_{offset} is slot offset in a period, T_{CSI-RS} is a period in a unit of slot, and l₀ and l₁ are OFDM symbol numbers in a slot. Specifically, a location of a subcarrier allocated to the first signal in frequency domain is described by using: an RB number n_{PRB}^{μ} or n_{CRB}^{μ} and a subcarrier number k in an RB. The first signal has the following features in frequency domain:

Feature F1: Including at least two frequency domain resource chunks, as shown in FIG. 4, including 3 frequency domain resource chunks.

Feature F2: In each frequency domain resource chunk, target subcarriers allocated to the first signal are uniformly distributed (“subcarriers allocated to the first signal” are referred to as “target subcarriers”), that is, the target subcarriers are distributed at equal spacings in frequency domain, and a spacing between the target subcarriers is referred to as a target subcarrier spacing.

Feature F3: The at least two frequency domain resource chunks have at least two different target subcarrier spacings.

Feature F4: A total bandwidth occupied by all target subcarriers allocated to the first signal meets the resolution requirement of the delay or the distance.

The total bandwidth is a total bandwidth between a target subcarrier of a minimum index and a target subcarrier of a maximum index in frequency domain.

Feature F5: In at least one frequency domain resource chunk of the at least two frequency domain resource chunks, a target subcarrier spacing meets the maximum unambiguous measurement range requirement of the delay or the distance.

Optionally, in addition to the foregoing features in frequency domain, the first signal

should further meet a condition: A bandwidth B₁ occupied by the first frequency domain chunk is greater than a maximum value Δfₘₐₓ of all target subcarrier spacing values. The first frequency domain chunk is a frequency domain resource chunk meeting Feature F5.

In an embodiment of this application, the first signal uses a chunk-wise uniform signal configuration in time domain and frequency domain. In this configuration, distribution of the first signal in time domain, that is, distribution of target OFDM symbols allocated to the first signal, uses the solution described in this application. A location of a target OFDM symbol allocated to the first signal in time domain meets Features T1 to T5. A location of an OFDM symbol allocated to the first signal in time domain is described by using: a system frame number n_{f}, a slot number n_{s,f}^{μ} in a system frame, and an OFDM symbol number 1 in a slot.

In addition, distribution of the first signal in frequency domain, that is, distribution of target subcarriers allocated to the first signal, uses the solution described in this application. A subcarrier allocated to the first signal meets Features F1 to F5 in frequency domain. A location of a subcarrier allocated to the first signal in frequency domain is described by using: an RB number n_{PRB}^{μ} or n_{CRB}^{μ} and a subcarrier number k in an RB.

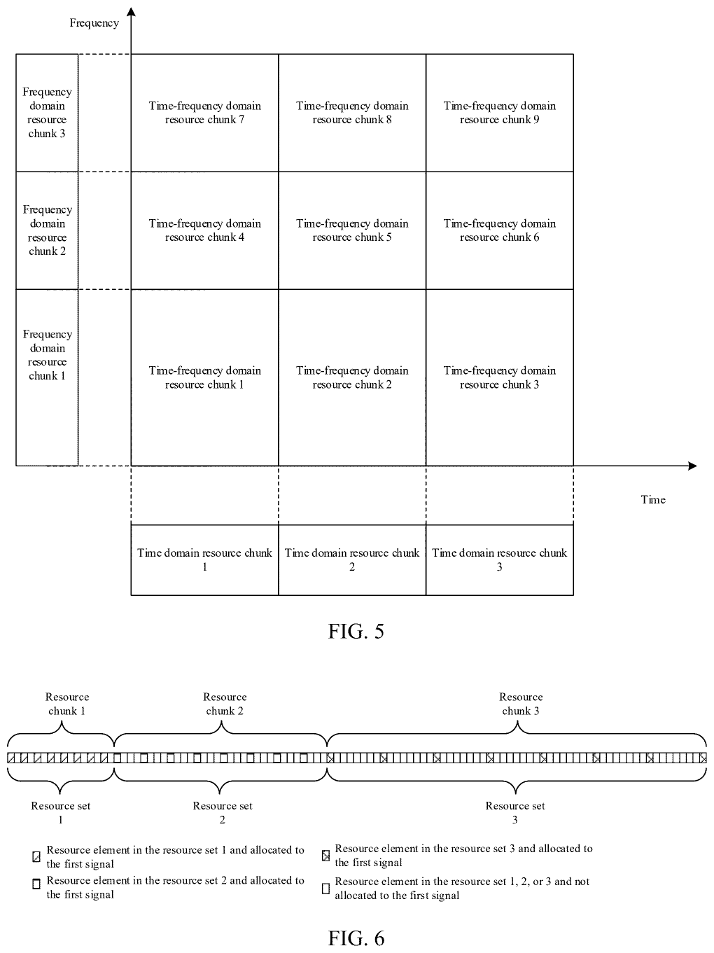

In this case, if the first signal includes M time domain resource chunks in time domain, and includes N frequency domain resource chunks in frequency domain, the first signal includes M×N time-frequency domain resource chunks in time-frequency domain, as shown in FIG. 5.

Optionally, in the method in this embodiment of this application, the parameter configuration information includes resource configuration information of one or more resource sets, each resource set includes at least one target resource element, and the at least two resource chunks include the one or more resource sets.

For a solution using a chunk-wise uniform signal configuration in time domain, target OFDM symbols belonging to the first signal are divided into several resource sets, there may be overlapping or no overlapping between the resource sets in time domain, and each resource set synthesizes, in time domain, a first signal meeting Feature T1 to Feature T5. Parameter configuration of the first signal is performed by using a resource set as a component.

For a solution using a chunk-wise uniform signal configuration in frequency domain, target subcarriers belonging to the first signal are divided into several resource sets, there may be overlapping or no overlapping between the resource sets in frequency domain, and each resource set synthesizes, in frequency domain, a first signal meeting Feature F1 to Feature F5. Parameter configuration of the first signal is performed by using a resource set as a component.

For a solution using a chunk-wise uniform signal configuration in time domain and frequency domain, {target OFDM symbols, target subcarriers} belonging to the first signal are divided into several resource sets, and there may be overlapping or no overlapping between the resource sets in time domain and/or frequency domain. A first signal synthesized by each resource set meets Features T1 to T5 in time domain and meets Features F1 to F5 in frequency domain. Parameter configuration of the first signal is performed by using a resource set as a component.

Optionally, a mapping relationship between the at least two resource chunks and the one or more resource sets meets at least one of the following:
at least one resource chunk is in a one-to-one correspondence with at least one resource set; or
at least one resource chunk is corresponding to at least two resource sets.

The mapping relationship between the resource chunk and the resource set is described in detail below with reference to an embodiment.

### Case A (caseA)

At least two resource chunks are in a one-to-one correspondence with a plurality of resource sets, that is, a resource chunk is equivalent to a resource set. As shown in FIG. 6, the first signal includes 3 resource chunks and 3 resource sets. It is easy to understand that, for ease of description, FIG. 6 provides a one-dimensional case, that is, a case in time domain or frequency domain (note that the case shown in FIG. 6 is merely to facilitate understanding of the technical solution, and does not represent any limitation on the technical solution of this application).

From a perspective of a feature of the first signal in the target domain, in the target domain, the first signal includes 3 resource chunks that meet Feature T1 to Feature T5 or Features F1 to F5, where a resource chunk 1 is a resource (that is, the first time domain chunk (the target domain is time domain) or the first frequency domain chunk (the target domain is frequency domain) that meets Feature T5 or Feature F5).

From a perspective of parameter configuration of the first signal, the example case in FIG. 6 is as follows:

A target resource element interval (or a repetition period of the target resource element, that is, a target OFDM symbol interval in time domain and a target subcarrier spacing in frequency domain) in a resource set 1 (which is also the resource chunk 1 in this case) is 2 target resource elements, and offset of a start location of the resource set 1 relative to a start location of the first signal is 0 target resource elements.

A target resource element interval (or a repetition period of the target resource element, that is, a target OFDM symbol interval in time domain and a target subcarrier spacing in frequency domain) in a resource set 2 (which is also the resource chunk 2 in this case) is 4 target resource elements, and offset of a start location of the resource set 2 relative to a start location of the first signal is 16 target resource elements.

A target resource element interval (or a repetition period of the target resource element, that is, a target OFDM symbol interval in time domain and a target subcarrier spacing in frequency domain) in a resource set 3 (which is also the resource chunk 3 in this case) is 8 target resource elements, and offset of a start location of the resource set 3 relative to a start location of the first signal is 48 target resource elements.

### Case B (caseB)

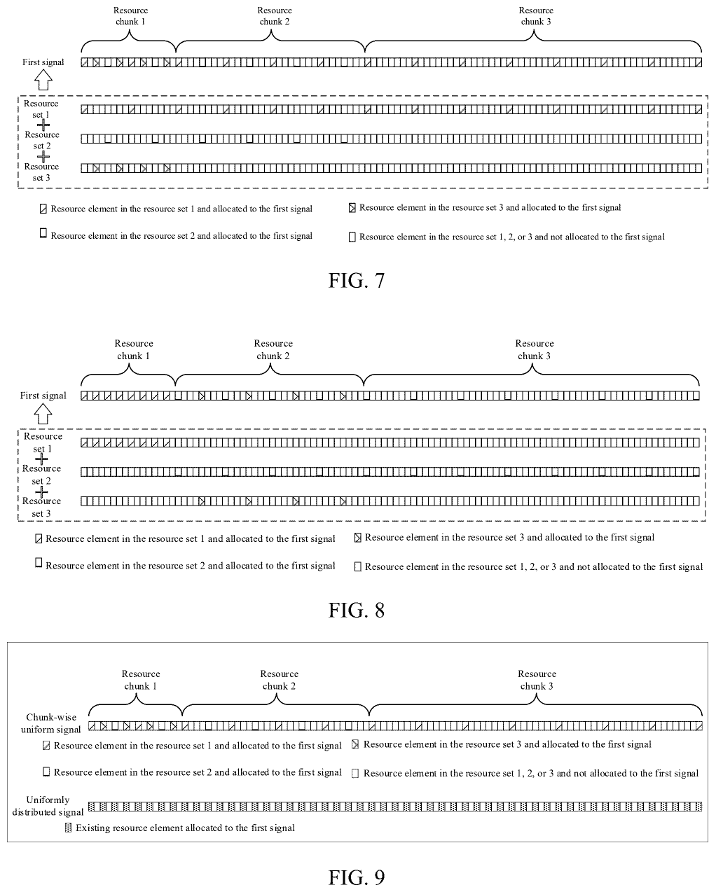

One resource chunk is corresponding to one or more resource sets. As shown in FIG. 7, FIG. 7 shows a first signal that is completely the same as that shown in FIG. 6, and a feature thereof in the target domain is completely the same as that in the case shown in FIG. 6 (note that the case shown in FIG. 7 is merely to facilitate understanding of the technical solution, and does not represent any limitation on the technical solution of this application).

Different from the case shown in FIG. 6, from a perspective of parameter configuration of the first signal, 3 resource sets cross-form the first signal.

A target resource element interval (or a repetition period of a target resource element) in a resource set 1 is 8 target resource elements, and offset of a start location of the resource set 1 relative to a start location of the first signal is 0 target resource elements.

A target resource element interval (or a repetition period of a target resource element) in a resource set 2 is 8 target resource elements, and offset of a start location of the resource set 2 relative to a start location of the first signal is 4 target resource elements.

A target resource element interval (or a repetition period of a target resource element) in a resource set 3 is 4 target resource elements, and offset of a start location of the resource set 3 relative to a start location of the first signal is 2 target resource elements.

### Case C (case C)

A mixture of case A and case B, where several resource sets are in a one-to-one correspondence with several resource chunks, and several other resource sets cross-form some other resource chunks. As shown in FIG. 8, FIG. 8 shows a first signal that is completely the same as that shown in FIG. 6 and FIG. 7, and a feature thereof in the target domain is completely the same as that in the cases shown in FIG. 6 and FIG. 7 (note that the case shown in FIG. 8 is merely to facilitate understanding of the technical solution, and does not represent any limitation on the technical solution of this application).

Different from the cases shown in FIG. 6 and FIG. 7, from a perspective of parameter configuration of the first signal, a resource set 1 and a chunk 1 are in a one-to-one correspondence, and a resource set 2 and a resource set 3 cross-form a chunk 2 and a chunk 3.

A target resource element interval (or a repetition period of a target resource element) in a resource set 1 is 2 target resource elements, and offset of a start location of the resource set 1 relative to a start location of the first signal is 0 target resource elements.

A target resource element interval (or a repetition period of a target resource element) in a resource set 2 is 8 target resource elements, and offset of a start location of the resource set 2 relative to a start location of the first signal is 16 target resource elements.

A target resource element interval (or a repetition period of a target resource element) in a resource set 3 is 8 target resource elements, and offset of a start location of the resource set 3 relative to a start location of the first signal is 20 target resource elements.

The foregoing three mapping manners between the resource chunk and the resource set are compared and analyzed as follows:

Initial configuration signaling overheads: When configuration of a first signal is performed before a sensing service is initially performed (for example, radio resource control (RRC) configuration signaling, where generally, RRC configuration signaling is used to configure a resource set, and combination of the first signal may be specifically completed by using L1 signaling, media access control control element (MAC CE) signaling, or RRC signaling), relatively low signaling overheads are caused when case A is used, followed by case B, and finally followed by case C. A premise is that according to the sensing requirement, it is obtained that the target OFDM symbol interval in the first time domain chunk or the target subcarrier spacing in the first frequency domain chunk can be supported in the NR protocol; otherwise, case A is unavailable.

For example, if the sensing requirement requires that the target OFDM symbol interval is 1 slot, and a minimum repetition period of a CSI-RS in a current version of the NR protocol is 4 slots, case A is unavailable. However, if a repetition period of 1 slot can be supported in a future version of the NR protocol, case A generally can obtain relatively low configuration overheads.

Configuration adjustment signaling overheads: In a sensing process, signal parameter adjustment may be performed according to sensing performance or resource overheads, so as to change a configuration parameter of the first signal. In this case, relatively low signaling overheads are usually caused when case B is used because signal parameters of more than one chunk can be changed by changing a parameter of one resource set. According to this idea, during configuration parameter adjustment, signaling overheads of case C are similar to those of case B, and signaling overheads of case A are greater than those of case B and case C.

For example, initial configuration of the first signal is the resource set 1, the resource set 2, and the resource set 3. Because a scenario changes, when the first signal needs to be adjusted, L1 signaling, MAC-CE signaling, or RRC signaling may be used. For example, when an adjusted first signal is the resource set 1, the resource set 2, and a resource set 4, a UE may be notified by using L1 signaling, MAC-CE signaling, or RRC signaling by using an ID of the resource set 4, thereby greatly reducing signaling overheads.

Change requirement of a current standard: In the current version of the NR protocol, in time domain, a minimum repetition period of a slot in which a CSI-RS is located is 4 slots and 1 or 2 OFDM symbols can be configured in the slot. In frequency domain, a subcarrier density in an RB in which the CSI-RS is located may be 0.5, 1, or 3, and a starting RB (startingRB) and a number of RBs (nrofRBs) may be only a multiple of 4. Therefore, according to the current version of the NR protocol and with reference to a typical scenario of integrated sensing and communication (such as traffic monitoring), the following cases occur:

In time domain, case A requires a standard to be compatible with a smaller repetition period of the CSI-RS (for example, the repetition period of the CSI-RS supports 1 slot), and case C is similar. Case B can be implemented according to configuration of the current version of the NR protocol.

In frequency domain, case B requires a standard to be compatible with more possible values of the starting RB, and smaller subcarrier densities (for example, the value of the starting RB can support a multiple of 4+1/+2/+3, and the subcarrier density can be 0.25, and a 0.125), and case C is similar. Case A can be implemented in many scenarios according to the current version of the NR protocol. A conclusion is shown in Table 2.

TABLE 2

| | |
|---|---|
| Initial configuration | case A ≤ case B ≤ case C |
| signaling overheads | |
| Configuration adjustment | case B ≈ case C ≤ case A |
| signaling overheads | |
| Change requirement of a | Time domain: case A = case C > case B |
| standard | Frequency domain: case B = case C > case A |

It may be learned from the foregoing description that parameter configuration of the first signal is performed by using a resource set as a component. Optionally, the resource configuration information of the one or more resource sets includes at least one of the following:

Item 1: a start location of the one or more resource sets in the target domain;

Item 2: a span of the one or more resource sets in the target domain;

Item 3: a resource interval between target resource elements in the one or more resource sets;

Item 4: a number of target resource elements in the one or more resource sets;

Item 5: a density of target resource elements in the one or more resource sets;

Item 6: a repetition period, in time domain, of a slot in which a target resource element in the one or more resource sets is located; for example, a repetition period, in time domain, of a slot in which a target OFDM symbol is located;

Item 7: a location of a target resource element in the one or more resource sets in a slot in which the target resource element is located; for example, a location of a target OFDM symbol in a slot in which the target OFDM symbol is located;

Item 8: a repetition period, in frequency domain, of a resource block RB in which a target resource element in the one or more resource sets is located; for example, a repetition period, in frequency domain, of an RB in which a target subcarrier is located;

Item 9: a location, in frequency domain, of an RB in which a target resource element in the one or more resource sets is located; for example, a location, in frequency domain, of an RB in which a target subcarrier is located; optionally, the location may be represented by using a bitmap (bitmap);

Item 10: a location of a target resource element in the one or more resource sets in an RB in which the target resource element is located; for example, a location of a target subcarrier in an RB in which the target subcarrier is located; or

Item 11: first indication information, where the first indication information is used to indicate that the target domain is time domain and/or frequency domain. For example, 1 bit is used for indication, bit 1 represents frequency domain, and bit 0 represents time domain;
where the span of the resource set in the target domain is a span between the first resource element and the last resource element of the resource set in the target domain. Optionally, the target resource element includes at least one of a target OFDM symbol

or a target subcarrier.

Optionally, for Item 1, the start location of the one or more resource sets in the target domain includes a start location of the one or more resource sets in time domain and/or a start location of the one or more resource sets in frequency domain. The start location of the one or more resource sets in time domain is indicated by at least one of a frame number, a half frame number, a subframe number, a slot number, or an OFDM symbol number; or the start location of the one or more resource sets in time domain includes time offset relative to a start location of the first signal in time domain, and a parameter of the time offset herein includes at least one of a number of frames, a number of half frames, a number of subframes, a number of slots, or a number of OFDM symbols. The start location of the one or more resource sets in frequency domain may be indicated by offset relative to a preset reference point. The preset reference point may be a point (point) A, a physical resource block (PRB) 0 of a BWP, and the offset may be indicated by at least one of the following: a number of resource block groups (RBG), a number of RBs, or a number of resource elements (RE). The start location of the one or more resource sets in frequency domain may alternatively be indicated by offset relative to a start location of the first signal in frequency domain. The offset may be indicated by at least one of the following: a number of RBGs, a number of RBs, or a number of REs.

For Item 2, the span of the one or more resource sets in the target domain includes a resource span of the one or more resource sets in time domain and/or frequency domain. The resource span of the one or more resource sets in time domain may be a span between an OFDM symbol of a maximum index and an OFDM symbol of a minimum index in the resource set in time domain. The resource span of the one or more resource sets in frequency domain may be a span between a subcarrier of a maximum index and a subcarrier of a minimum index in the resource set in frequency domain.

For Item 3, the resource interval between the target resource elements in the one or more resource sets includes at least one of a target OFDM symbol interval in the one or more resource sets or a target subcarrier spacing in the one or more resource sets.

For Item 4, the number of target resource elements in the one or more resource sets includes at least one of a number of target OFDM symbols or a number of target subcarriers in the one or more resource sets.

For Item 5, the density of the target resource elements in the one or more resource sets

includes at least one of a density of target OFDM symbols or a density of target subcarriers in the one or more resource sets. The density of the target OFDM symbols in the one or more resource sets is a number of target OFDM symbols included in a preset number of consecutive OFDM symbols in time domain, or a ratio of a number of target OFDM symbols included in a preset number of consecutive OFDM symbols in time domain to the preset number. For example, in time domain, 2 symbols in one slot (14 symbols) are allocated to the first signal, and a density of the target OFDM symbols may be represented as 2 or 1/7.

The density of the target subcarriers in the one or more resource sets is a number of target subcarriers included in a preset number of consecutive subcarriers in frequency domain, or a ratio of a number of target subcarriers included in a preset number of consecutive subcarriers in frequency domain to the preset number. For example, in frequency domain, if 2 subcarriers in one RB (12 subcarriers) are allocated to the first signal, the density of the target subcarriers may be represented as 3 or ¼.

Optionally, the parameter configuration information further includes at least one of the following:
a start location of the first signal in the target domain;
a resource span of the first signal in the target domain; or
a repetition period of the first signal in time domain;
where the resource span of the first signal in the target domain is a span between the first target resource element and the last target resource element of the at least two resource chunks in the target domain.

The start location of the first signal in the target domain includes a start location of the first signal in time domain and/or frequency domain, where the start location of the first signal in time domain includes a time domain location indicated by at least one of a frame number, a half frame number, a subframe number, a slot number, or an OFDM symbol number, or includes time offset relative to a preset reference signal, for example, time offset relative to an SSB sent periodically. A parameter of the time offset herein includes at least one of a number of frames, a number of half frames, a number of subframes, a number of slots, or a number of OFDM symbols. The start location of the first signal in frequency domain includes offset relative to a preset reference point, and the preset reference point includes one of the following: point A and a PRB0 of an activated BWP. The offset may be indicated by at least one of a quantity of resource block groups (RBG), a quantity of RBs, or a quantity of REs.

The resource span of the first signal in the target domain includes a resource span of the first signal in time domain and/or a resource span of the first signal in frequency domain, where the resource span of the first signal in time domain is a time span between an OFDM symbol that is allocated in time domain to the first signal and that is of a maximum index and an OFDM symbol that is allocated in time domain to the first signal and that is of a minimum index, and the resource span of the first signal in frequency domain is a time span between a subcarrier that is allocated in frequency domain to the first signal and that is of a maximum index and a subcarrier that is allocated in frequency domain to the first signal and that is of a minimum index.

It should be noted that the parameter configuration information is only a possible configuration parameter set. In specific implementation, a signal that meets Feature 1 to Feature 5 may alternatively be implemented by using another configuration parameter set, which also falls within the protection scope of this application.

The resource span of the first signal in time domain, the span of the resource set in time domain, the target OFDM symbol interval, and a granularity of the location of the target OFDM symbol in time domain may be at least one of the following: a preset time length (for example, 1 ms), OFDM symbol duration, a slot, a subframe, a half frame, or a frame.

The resource span of the first signal in frequency domain, the span of the resource set in frequency domain, the target subcarrier spacing, and a granularity of a location, in frequency domain, of the slot in which the target subcarrier is located may be at least one of the following: a preset frequency width (such as 30 kHz), a subcarrier, an RB, or an RBG.

In an embodiment of this application, an example in which a configuration parameter of an existing NR reference signal (for example, a CSI-RS) is used to implement parameter configuration of the first signal is used for description, or an example in which a configuration parameter of an existing NR reference signal is slightly extended to implement parameter configuration of the first signal is used for description. Specifically, the parameter configuration information of the first signal includes at least one of the following:

Item 1: a time domain configuration parameter; or

Item 2: a frequency domain configuration parameter.

The time domain configuration parameter includes at least one of the following:
B1: a start location of the first signal in time domain;
B2: a start location of each resource set of the first signal in time domain, where starting of a corresponding resource set in time domain is indicated by radio resource control (RRC) configuration, or media access control control element (MAC CE), downlink control information (DCI) signaling, or combination signaling of the MAC CE and DCI.

For example, if a start location of a resource set in time domain is required to be a slot n, there are two methods: One is a method of re-RRC configuration, and the other is a method for activating (namely, activation) a new resource set by using the MAC CE or the DCI.
B3: a repetition period of a slot in which a target OFDM symbol in each resource set of the first signal is located;
B4: a location of a target OFDM symbol in each resource set of the first signal in a slot in which the target OFDM symbol is located, for example, indicated by l₀ or l₀ and l₁.

Note: Target OFDM symbols in different resource sets in time domain may be at a same location or different locations in slots in which the target OFDM symbols are located. A number of target OFDM symbols in slots in which target OFDM symbols in different resource sets are located in time domain may be the same or different.
B5. an end location of each resource set of the first signal in time domain, where ending of a corresponding resource set is indicated by using RRC configuration, a MAC CE, DCI signaling, or combination signaling of the MAC CE and DCI.

For example, if a resource set is required to end in a slot n, there are two methods: One is a method of re-RRC configuration, and the other is a method for deactivating (namely, deactivation) a corresponding resource set (Resource Set) by using the MAC CE or the DCI.
B6: a repetition period of the first signal in time domain, that is, a time interval between two adjacent times of receiving and transmitting the first signal to perform a sensing process, where this parameter represents sensing refresh time or refresh frequency.

The frequency domain configuration parameter includes at least one of the following:
C1: a start location of the first signal in frequency domain;
C2: a start location of each resource set of the first signal in frequency domain;
C3: a repetition period, in frequency domain, of an RB in which a target subcarrier in each resource set of the first signal is located, in a unit of RB or RBG;
C4: a location of a target subcarrier in each resource set in frequency domain of the first signal in an RB in which the target subcarrier is located, for example, represented by a bitmap;
C5: a location, in frequency domain, of an RB in which a target subcarrier in each resource set of the first signal is located, for example, represented by a bitmap, where one bit of the bitmap represents one RB or one RBG; or
C6: a bandwidth occupied by each resource set of the first signal in frequency domain, that is, a bandwidth or a number of RBs corresponding to all subcarriers included between a target subcarrier of a minimum index and a target subcarrier of a maximum index in each resource set, or a bandwidth corresponding to all RBs or RBGs included between an RB or an RBG in which a target subcarrier of a minimum index is located and an RB or an RBG in which a target subcarrier of a maximum index is located in each resource set, where a representation manner may be a preset bandwidth (for example, 100 MHz) or a number of RBs/RBGs.

FIG. 9 is a schematic diagram of comparing resource overheads of using a chunk-wise uniform signal in this application and an equivalent existing uniformly distributed signal. It may be learned from FIG. 9 that the resource overheads of the chunk-wise uniform signal in this application are greatly reduced compared with the resource overheads of the equivalent uniformly distributed signal. In addition, the chunk-wise uniform signal described in this application is equivalent to the equivalent uniformly distributed signal in terms of resolution and maximum unambiguous measurement range performance of the delay (distance) and/or the Doppler (speed).

The following describes the method in this application in detail with reference to a specific embodiment.

In a first embodiment of this application, a chunk-wise uniform signal configuration method provided in this application is used in time domain to configure a first signal. However, configuration is performed in frequency domain according to another configuration method, for example, configuration of conventional uniform distribution (or comb distribution) is used in frequency domain.

In this case, a configuration parameter of the first signal in time domain includes at least one of the following:
first indication information, where the first indication information indicates that a target domain is time domain, for example, 1 bit is used for indication, and bit ‘0’ indicates time domain;
a start location of the first signal in time domain;
a total span of the first signal in time domain;
a start location of one or more resource sets in time domain;
a span of one or more resource sets in time domain;
a location, in time domain, of a target OFDM symbol in one or more resource sets;
a target OFDM symbol interval in one or more resource sets;
a number of target OFDM symbols in one or more resource sets;
a density of target OFDM symbols in one or more resource sets;
a repetition period, in time domain, of a slot in which a target OFDM symbol in one or more resource sets is located; or
a location of a target OFDM symbol in one or more resource sets in a slot in which the target OFDM symbol is located.

In addition to the foregoing configuration in time domain, configuration of the first signal further needs to include configuration in frequency domain. In this embodiment, conventional uniform distribution configuration is used for configuration in frequency domain, including at least one of the following:
an indication that the target domain is frequency domain, where for example, 1 bit is used for indication, and the bit being ‘1’ indicates frequency domain;
a start location of a target resource in frequency domain;
a total span of a target resource in frequency domain;
a target subcarrier spacing of a target resource in frequency domain;
a number of target carriers of a target resource in frequency domain; or
a target subcarrier density of a target resource in frequency domain.

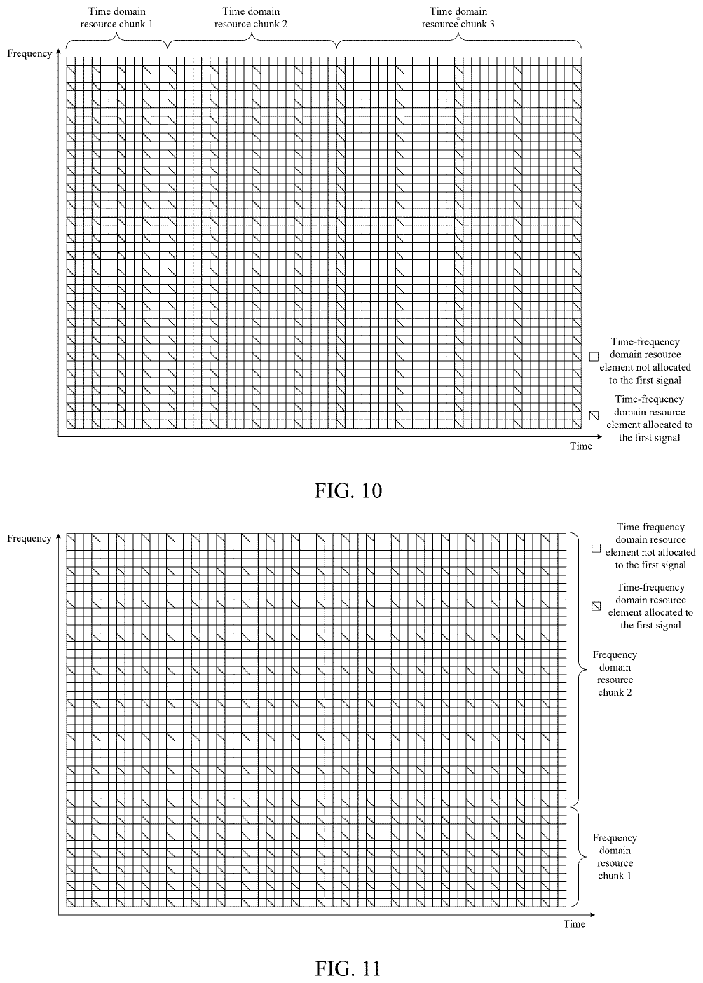

As shown in FIG. 10, one grid in a time dimension represents one OFDM symbol in time domain, and one grid in frequency dimension represents one subcarrier. Therefore, one square grid represents a time-frequency domain resource element including one OFDM symbol and one subcarrier. It should be noted that the schematic diagram is only used to facilitate understanding of the technical solution in this embodiment, and does not represent that signal configuration in this embodiment is limited to content shown in FIG. 10.

In FIG. 10, chunk-wise uniform signal configuration is used in time domain. The first signal includes 3 time domain resource chunks in time domain: A target OFDM symbol interval in a time domain resource chunk 1 is 3 OFDM symbols, a target OFDM symbol interval in a time domain resource chunk 2 is 5 OFDM symbols, and a target OFDM symbol interval in a time domain resource chunk 3 is 7 OFDM symbols. In another aspect, conventional configuration of uniformly distributed signals is used in frequency domain, and a target subcarrier spacing in frequency domain is 2 subcarriers.

In FIG. 10, the time domain resource chunk 1 is a time domain resource chunk (that is, the first time domain chunk) that meets the foregoing Feature T5, and total duration of the time domain resource chunk 1, the time domain resource chunk 2, and the time domain resource chunk 3 meets the foregoing Feature T4. The target OFDM symbol interval in each of the time domain resource chunk 2 and the time domain resource chunk 3 is greater than the target OFDM symbol interval in the time domain resource chunk 1, thereby reducing resource overheads of the first signal.

In a second embodiment of this application, in frequency domain, a chunk-wise uniform signal configuration method in this application is used to configure a first signal. However, configuration is performed in time domain according to another configuration method, for example, configuration of conventional uniformly distributed first signals is used in time domain.

In this case, a configuration parameter of the first signal in frequency domain includes at least one of the following:

first indication information, where the first indication information indicates that a target domain is frequency domain, for example, 1 bit is used for indication, and bit ‘1’ indicates frequency domain;
a start location of the first signal in frequency domain;
a total span of the first signal in frequency domain;
a start location of one or more resource sets in frequency domain;
a span of one or more resource sets in frequency domain;
a location, in frequency domain, of a target subcarrier in one or more resource sets;
a target subcarrier spacing in one or more resource sets;
a number of target subcarriers in one or more resource sets;
a density of target subcarriers in one or more resource sets;
a repetition period, in frequency domain, of an RB in which a target subcarrier in one or more resource sets is located; or
a location of a target subcarrier in one or more resource sets in an RB in which the target subcarrier is located.

In addition to the foregoing configuration in frequency domain, configuration of the first signal further needs to include configuration in time domain. In this embodiment, conventional uniform distribution configuration is used for configuration in time domain, including at least one of the following:
an indication that the target domain is time domain, where for example, 1 bit is used for indication, and the bit being ‘0’ indicates time domain;
a start location of a target resource in time domain;
a total span of a target resource in time domain;
a target OFDM symbol interval of a target resource in time domain;
a number of target OFDM symbols of a target resource in time domain; or
a density of target OFDM symbols of a target resource in time domain.

As shown in FIG. 11, one grid in a time dimension represents one OFDM symbol in time domain, and one grid in frequency dimension represents one subcarrier in FIG. 11. Therefore, one square grid represents a time-frequency domain resource element including one OFDM symbol and one subcarrier. The schematic diagram is only used to facilitate understanding of the technical solution in this embodiment, and does not represent that signal configuration in this embodiment is limited to content shown in the figure.

In FIG. 11, the chunk-wise uniform signal configuration described in this application is used in frequency domain. The first signal includes 2 frequency domain resource chunks in frequency domain: A target subcarrier spacing in the frequency domain resource chunk 1 is 2 subcarriers, and a target subcarrier spacing in the frequency domain resource chunk 2 is 4 subcarriers. In another aspect, conventional configuration of uniformly distributed signals is used in time domain, and a target OFDM symbol interval in time domain is 3 OFDM symbols.

In FIG. 11, the frequency domain resource chunk 1 is a chunk (that is, the first frequency domain chunk) that meets Feature F5, and a total bandwidth of the frequency domain resource chunk 1 and the frequency domain resource chunk 2 meets Feature F4. The target subcarrier spacing in the frequency domain resource chunk 2 is greater than the target subcarrier spacing in the frequency domain resource chunk 1, thereby reducing resource overheads of the first signal.

In a third embodiment of this application, a chunk-wise uniform signal configuration method is used to configure a first signal in both time domain and frequency domain.

In this case, parameter configuration information of the first signal includes:
a time domain configuration parameter; and
a frequency domain configuration parameter.

The time domain configuration parameter includes at least one of the following:
first indication information, where the first indication information indicates that a target domain is time domain, for example, 1 bit is used for indication, and bit ‘0’ indicates time domain;
a start location of the first signal in time domain;
a total span of the first signal in time domain;
a start location of one or more resource sets in time domain;
a span of one or more resource sets in time domain;
a location, in time domain, of a target OFDM symbol in one or more resource sets;
a target OFDM symbol interval in one or more resource sets;
a number of target OFDM symbols in one or more resource sets;
a density of target OFDM symbols in one or more resource sets;
a repetition period, in time domain, of a slot in which a target OFDM symbol in one or more resource sets is located; or
a location of a target OFDM symbol in one or more resource sets in a slot in which the target OFDM symbol is located.

The frequency domain configuration parameter includes at least one of the following:
first indication information, where the first indication information indicates that a target domain is frequency domain, for example, 1 bit is used for indication, and bit ‘l’ indicates frequency domain;
a start location of the first signal in frequency domain;
a total span of the first signal in frequency domain;
a start location of one or more resource sets in frequency domain;
a span of one or more resource sets in frequency domain;
a location, in frequency domain, of a target subcarrier in one or more resource sets;
a target subcarrier spacing in one or more resource sets;
a number of target subcarriers in one or more resource sets;
a density of target subcarriers in one or more resource sets;
a repetition period, in frequency domain, of an RB in which a target subcarrier in one or more resource sets is located; or
a location of a target subcarrier in one or more resource sets in an RB in which the target subcarrier is located.

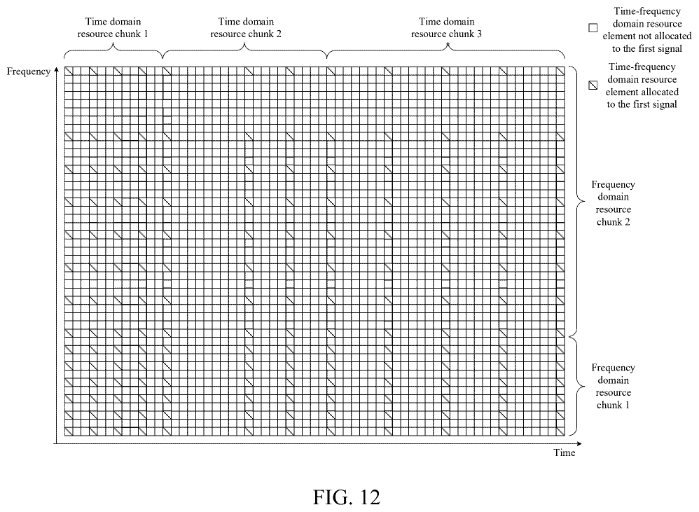

As shown in FIG. 12, one grid in a time dimension represents one OFDM symbol in time domain, and one grid in frequency dimension represents one subcarrier in FIG. 12. Therefore, one square grid represents a time-frequency domain resource element including one OFDM symbol and one subcarrier. The schematic diagram is only used to facilitate understanding of the technical solution in this embodiment, and does not represent that signal configuration in this embodiment is limited to what is shown in the figure.

In FIG. 12, chunk-wise uniform signal configuration is used in time domain and frequency domain. The first signal includes 3 time domain resource chunks in time domain: A target OFDM symbol interval in a time domain resource chunk 1 is 3 OFDM symbols, a target OFDM symbol interval in a time domain resource chunk 2 is 4 OFDM symbols, and a target OFDM symbol interval in a time domain resource chunk 3 is 7 OFDM symbols. The first signal includes 2 resource chunks in frequency domain: A target subcarrier spacing in a frequency domain resource chunk 1 is 2 subcarriers, and a target subcarrier spacing in a frequency domain resource chunk 2 is 4 subcarriers.

In FIG. 12, the time domain resource chunk 1 meets the foregoing Feature T5, and total duration of the time domain resource chunk 1, the time domain resource chunk 2, and the time domain resource chunk 3 meets Feature T4. The frequency domain resource chunk 1 meets Feature F5, and a total bandwidth of the frequency domain resource chunk 1 and the frequency domain resource chunk 2 meets Feature F4. The target OFDM symbol interval in each of the time domain resource chunk 2 and the time domain resource chunk 3 is greater than the target OFDM symbol interval in the time domain resource chunk 1, and the target subcarrier spacing in the frequency domain resource chunk 2 is greater than the target subcarrier spacing in the frequency domain resource chunk 1, thereby reducing resource overheads.

Optionally, in this embodiment of this application, the first signal is configured as single-port or multi-port; and
in a case that the first signal is configured as multi-port, resources of first signals of different ports meet at least one of the following:
frequency division multiplexing;
time division multiplexing;
resource patterns of the first signals of the different ports in the target domain are the same, and generation sequences used for the first signals of the different ports are different; or resource patterns of the first signals of the different ports in the target domain are the same, generation sequences used for the first signals of the different ports are the same, and orthogonal covering codes corresponding to different first signals are different.

In this embodiment of this application, the first signal may be configured as multi-port, and a pattern relationship between first signals of different ports may include the following cases:

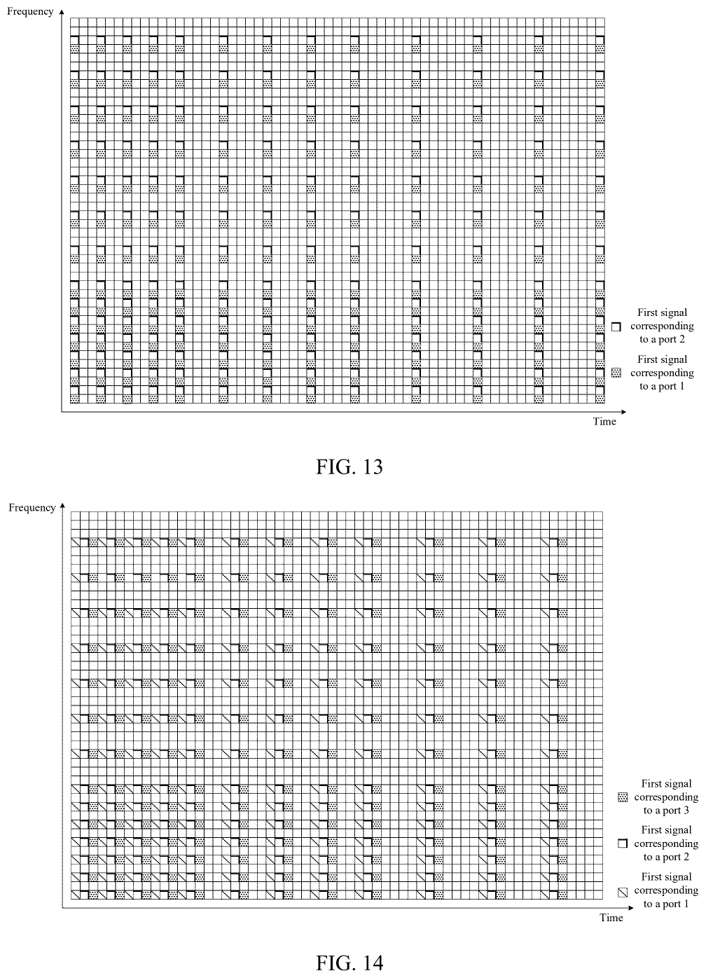

Case 1: First signals of different ports use frequency division multiplexing, that is, first signals of different ports are distinguished by configuring different frequency domain offsets. For example, as shown in FIG. 13, frequency division multiplexing is performed on two ports, a first signal frequency domain offset corresponding to a port 1 is 0 subcarriers, a first signal frequency domain offset corresponding to a port 2 is 1 subcarrier, and total resource spans and resource distribution of the port 1 and the port 2 are the same in frequency domain, that is, they have same sensing performance.

Case 2: First signals of different ports use time division multiplexing, that is, first signals of different ports are distinguished by configuring different time domain offsets. For example, as shown in FIG. 14, time division multiplexing is performed on three ports, a first signal time domain offset corresponding to a port 1 is 0 OFDM symbols, a first signal time domain offset corresponding to a port 2 is 1 OFDM symbol, a first signal time domain offset corresponding to a port 3 is 2 OFDM symbols, and total resource spans and resource distribution of the port 1, the port 2, and the port 3 are the same in time domain, that is, they have same sensing performance.

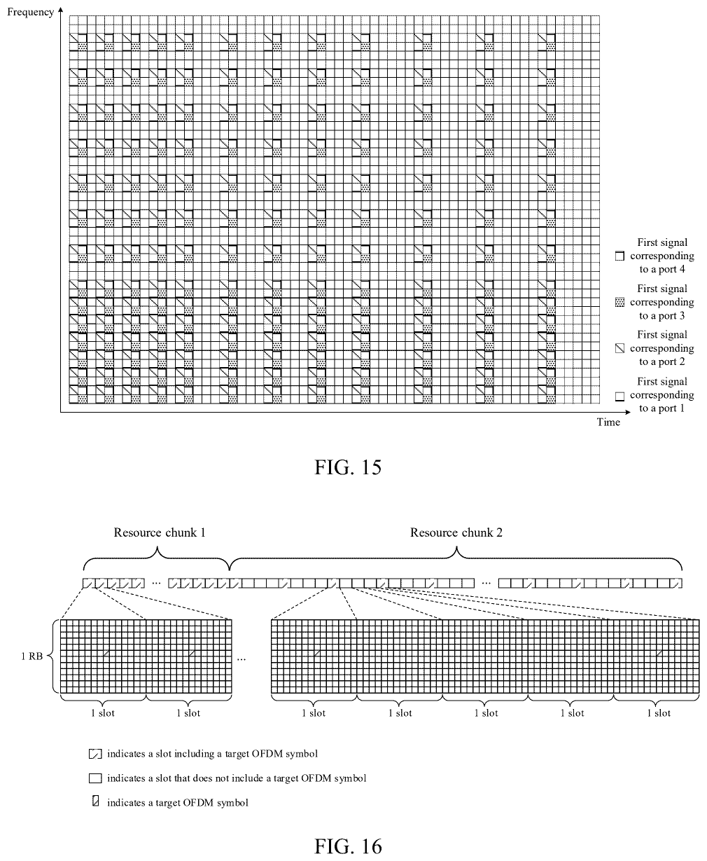

Case 3: First signals of different ports use frequency division multiplexing and time division multiplexing, that is, first signals of different ports are distinguished by configuring different frequency domain offsets and time domain offsets. For example, as shown in FIG. 15, frequency division multiplexing and time division multiplexing (FD2-TD2) are performed on four ports: A first signal frequency domain offset corresponding to a port 1 is 0 subcarriers, and a time domain offset corresponding thereto is 0 OFDM symbols; a first signal frequency domain offset corresponding to a port 2 is 1 subcarrier, and a time domain offset corresponding thereto is 0 OFDM symbols; a first signal frequency domain offset corresponding to a port 3 is 0 subcarriers, and a time domain offset corresponding thereto is 1 OFDM symbol; and a first signal frequency domain offset corresponding to a port 4 is 1 subcarrier, and a time domain offset corresponding thereto is 1 OFDM symbol. Total resource spans and resource distribution of the port 1, the port 2, the port 3, and the port 4 are the same in time domain and frequency domain, that is, they have same sensing performance.

Case 4: First signals of different ports have a same pattern in a target domain, that is, have a same time domain or frequency domain configuration parameter. However, used generation sequences of the first signals are different, that is, a generation parameter of a first signal sequence is related to a port sequence number.

Case 5: First signals of different ports have a same pattern in a target domain, that is, have a same time domain or frequency domain configuration parameter, and use a same generation sequence of the first signals, but are distinguish by using different orthogonal covering codes (OCC) when mapped to time domain or frequency domain resources. For example, when 2-port first signal mapping uses a frequency domain orthogonal covering code (FD-OCC), a first signal sequence of a port 1 is c(m), and may be directly mapped to a frequency unit (for example, an RE) corresponding to a specified time unit (for example, an OFDM symbol). A first signal sequence of a port 2 may be c(m)*occ(m), and occ(m) is an FD-OCC sequence, may be represented as (1, −1, 1, −1 . . , 1, −1, 1, −1), and then is mapped to a same frequency unit as that of the port 1.

The following describes the method in this embodiment of this application by using an example in which the first signal is an NR reference signal CSI-RS. Certainly, another reference signal or synchronization signal such as a demodulation reference signal (DMRS), a phase-tracking reference signal (PTRS), a positioning reference signal (PRS), or a synchronization signal block (SSB), also falls within the protection scope of this application.

In a fourth embodiment of this application, the chunk-wise uniform signal described in this application is used in time domain. A distribution situation of the first signal in frequency domain is not limited herein. In some embodiments, subcarriers assigned to the first signal are arranged in conventional uniform distribution (namely, comb distribution) in frequency domain, for example, a kth subcarrier in each RB in a BWP in which the first signal is located is assigned to the first signal, where k is a subcarrier number in the RB.

As shown in FIG. 16, the chunk-wise uniform signal described in this application is used in time domain. The first signal includes 2 resource chunks in time domain, and there is 1 target OFDM symbol in each slot that includes a target OFDM symbol. In a resource chunk 1, a repetition period of a slot in which a target OFDM symbol is located is 1 slot, and therefore, a target OFDM symbol interval is also 1 slot, which meets a maximum unambiguous measurement requirement of Doppler or a speed in a sensing requirement. In a resource chunk 2, a repetition period of a slot in which a target OFDM symbol is located is 4 slots, and therefore, a target OFDM symbol interval is 4 slots. A total time length occupied by the resource chunk 1 and the resource chunk 2 in time domain meets a resolution requirement of the Doppler or the speed.

A typical scenario of this configuration is as follows: For a communication function, a CSI-RS in one slot appears on 1 OFDM symbol, and a repetition period of the CSI-RS is configured as 4 slots, which can meet a requirement. For a sensing scenario (measurement of the Doppler or the speed herein), an unambiguous measurement range of the Doppler or the speed requires that an OFDM symbol interval of CSI-RS is not greater than 1 slot. If CSI-RS configuration that meets the sensing requirement is used in all slots, relatively high overheads are brought. In the method described in this application, the CSI-RS configuration that meets the sensing requirement needs to be used only in some slots, but CSI-RS configuration that meets a communication function still needs to be used in remaining slots, so that additional overheads brought are relatively small while the sensing requirement is met.

In this embodiment, the following two cases are considered for a configuration parameter of the first signal:

Case 1: Parameter configuration of the first signal is performed according to case A.

In a current NR standard, a minimum repetition period of a CSI-RS in time domain is 4 slots. In this embodiment, a repetition period of a slot in which a target OFDM symbol in a chunk 1 of the first signal is located is 1 slot. A premise for performing configuration in the manner of case A is that in a future NR version, a number of slots of a repetition period of a CSI-RS in time domain can be smaller, so as to support a sensing function (specifically, measurement of the Doppler or the speed).

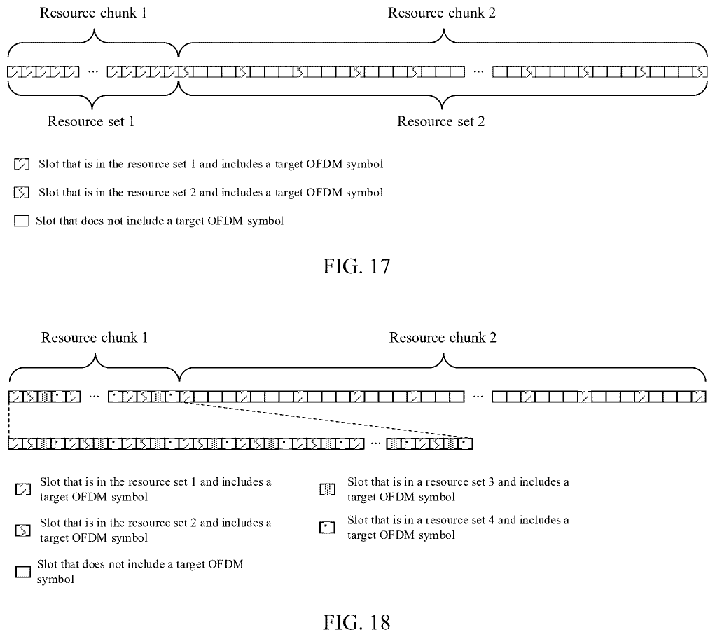

In this case, the first signal in FIG. 16 is divided into 2 resource sets. A resource set 1 is corresponding to the resource chunk 1 and a resource set 2 is corresponding to the resource chunk 2. As shown in FIG. 17, a repetition period of a slot that includes a target OFDM symbol in a resource set 1 is 1 slot, and a repetition period of a slot that includes a target OFDM symbol in a resource set 2 is 4 slots.

Case 2: Parameter configuration of the first signal is performed according to case B.

According to a repetition period of a CSI-RS in time domain in a current NR standard, parameter configuration may be performed in a manner of crossing each resource set. As shown in FIG. 18, 4 resource sets are included herein, and a repetition period in each resource set is 4 slots. However, a start location of each resource set is different, and a parameter field in existing NR may be used for configuration.

It may be learned that, for the case of this embodiment, the manner of case B may be used for configuration according to the current version NR standard.

Regardless of whether the foregoing manner of case A or case B is used for signal parameter configuration, signal configuration is performed by using a resource set as a component. Therefore, a configuration parameter used to describe the first signal that meets the foregoing features includes the following content:
(1) a start location of the first signal in time domain, which is an index of the first slot occupied by the first signal in time domain, and is denoted as Nₛₗₒₜ^{frame,μ}n_{f}+n_{s,f}^{μ}, where n_{f} is a system frame number, Nₛₗₒₜ^{frame,μ} is a number of slots included in one system frame, and n_{s,f}^{μ} is a slot number in one system frame;
(2) a start location of each resource set of the first signal in time domain, which is an index of the first slot of the resource set of the first signal in time domain, is denoted as slot offset relative to starting of the first signal, is represented as T_{offset} in a unit of slot, and may be configured by using CSI-ResourcePeriodicity AndOffset or CSI-RS-Resource-Mobility->slotConfig; or
the configuration parameter of the first signal does not include start locations of at least some resource sets; instead, RRC configuration, or a MAC CE, DCI signaling, or combination signaling of the MAC CE and DCI is used to indicate starting of a corresponding resource set in time domain;
(3) a repetition period of each resource set of the first signal in time domain, which is a repetition period of a slot that is in the resource set of the first signal in time domain and that includes a target OFDM symbol, is represented as T_{CSI-RS} in a unit of slot, and may be configured by using CSI-ResourcePeriodicity AndOffset or CSI-RS-Resource-Mobility->slotConfig;
(4) an index of a target OFDM symbol a slot that is in each resource set of the first signal and that includes a target OFDM symbol, which is, for example, represented as l₀ in a unit of OFDM symbol (when there is only one target OFDM symbol), or l₀ and l₁ (when there are 2 target OFDM symbols), and may be configured by using firstOFDMSymbolInTimeDomain and/or firstOFDMSymbolInTimeDomain2;
(5) an end location of each resource set of the first signal in time domain, where ending of a corresponding resource set is indicated by using RRC configuration, a MAC CE, DCI signaling, or combination signaling of the MAC CE and DCI;
(6) beam ID: All resource sets belonging to a same first signal should be associated with a same beam, that is, there is a QCL relationship between all the resource sets, and may be configured by using tci-StatesToAddModList, each resource set may be configured as QCL, or each resource set and a same another signal (such as an SSB) may be configured as QCL; and
(7) resource set list: A list of IDs of all resource sets belonging to a same first signal, which is used to notify a receive end of the first signal which resource sets belong to the corresponding first signal.

In a fifth embodiment of this application, the chunk-wise uniform signal described in this application is used in frequency domain. A distribution situation of the first signal in time domain is not limited herein. In some embodiments, OFDM symbols assigned to the first signal are arranged in conventional uniform distribution (namely, comb distribution) in time domain. For example, in a slot meeting (Nₛₗₒₜ^{frame,μ}n_{f}+n_{s,f}^{μ}−T_{offset})mod T_{CSI-RS}=0, a 10th and/or an 11th OFDM symbols are allocated to the first signal, where Nₛₗₒₜ^{frame,μ} is a slot count included in one system frame, ne is a system frame number, n_{s,f}^{μ}, is a slot number in a system frame, T_{offset} is slot offset in a period, T_{CSI-RS} is a period in a unit of slot, and 10 and 11 are OFDM symbol numbers in a slot.

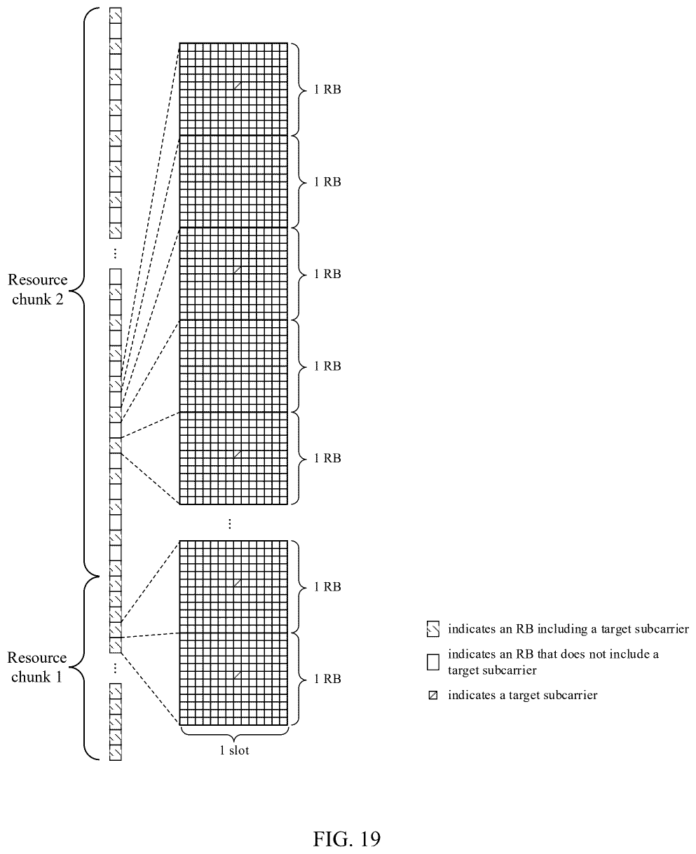

As shown in FIG. 19, the chunk-wise uniform signal described in this application is used in frequency domain. The first signal includes 2 resource chunks in frequency domain, and each RB that includes a target subcarrier includes 1 target subcarrier. In a resource chunk 1, a target subcarrier spacing is 1 RB, which meets a maximum unambiguous measurement requirement of a delay or a distance in a sensing requirement. In a resource chunk 2, a target subcarrier spacing is 2 RBs, and a total bandwidth occupied by the resource chunk 1 and the resource chunk 2 in frequency domain meets a resolution requirement of the delay or the distance.

For a configuration parameter of the first signal in this embodiment, the following two cases are considered, which are respectively corresponding to case A and case B in the technical solution.
(1) Parameter configuration of the first signal is performed according to case A.

In a current NR standard, a maximum density of a CSI-RS in frequency domain is 3, that is, 3 subcarriers in 1 RB are allocated to the CSI-RS. For this embodiment, subcarrier density configuration in the current NR standard can meet a requirement.

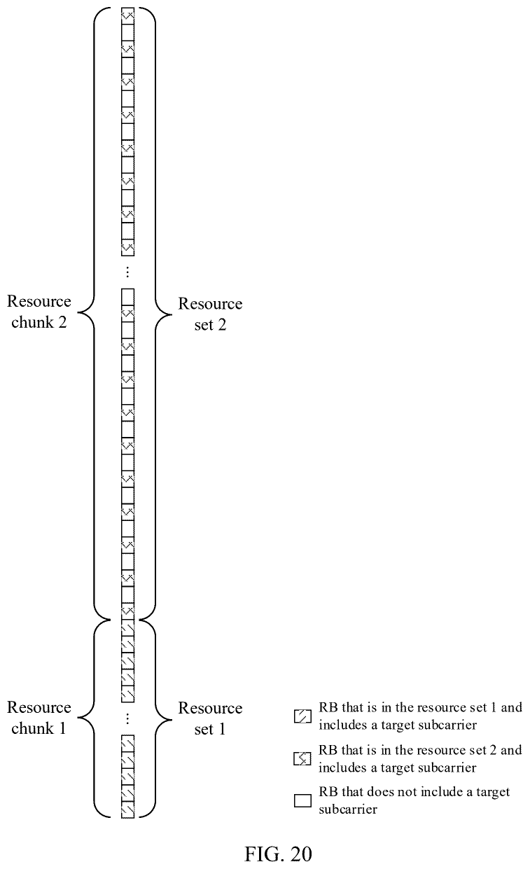

In this configuration manner, the first signal in FIG. 19 is divided into 2 resource sets, as shown in FIG. 20. A density of target subcarriers in a resource set 1 is 1, that is, 1 target subcarrier exists in 1 RB. A density of target subcarriers in a resource set 2 is 0.5, that is, 1 target subcarrier exists in 2 RBs.
(2) Parameter configuration of the first signal is performed according to case B.

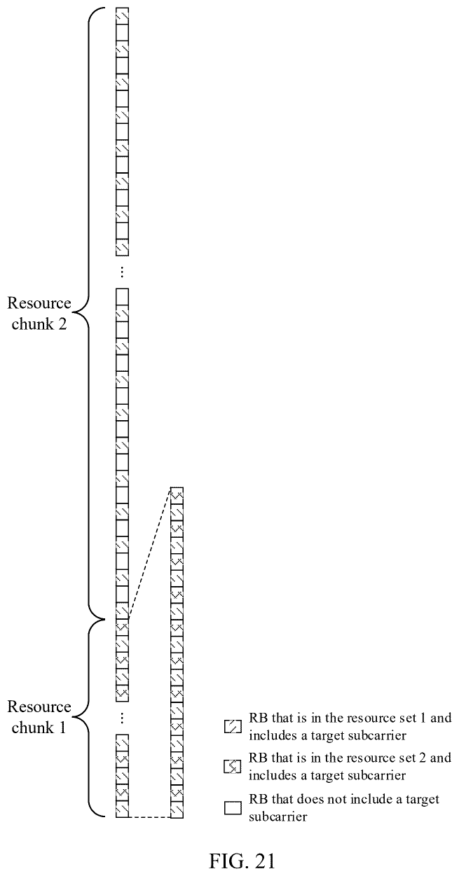

Parameter configuration is performed in a manner of crossing each resource set in frequency domain, which has greater flexibility and can implement any required target subcarrier spacing. Certainly, for this embodiment, a subcarrier density in the current version of the NR standard is sufficient. As shown in FIG. 21, when configuration is performed in the manner of case B, 2 resource sets are included, and a density of target subcarriers in each resource set is 0.5, that is, 1 target subcarrier exists in every 2 RBs.

Regardless of whether the foregoing manner of case A or case B is used for signal parameter configuration, signal configuration is performed by using a resource set as a component. Therefore, a configuration parameter used to describe the first signal that meets the foregoing features includes at least one of the following content:
(1) a start location of the first signal in frequency domain, which is an RB of a minimum index occupied by the first signal in frequency domain, and may be configured by using CSI-frequencyOccupation->startingRB;
(2) a start location of each resource set of the first signal in frequency domain, which is an RB of a minimum index of the resource set of the first signal in frequency domain, and may be configured by using CSI-frequencyOccupation->startingRB;
note: in the current version of the NR protocol, a value of a starting RB can only be an integer multiple of 4; and if the manner of case B is used, the value of the starting RB may need to be more flexible;
(3) a density of target subcarriers in each resource set of the first signal, that is, a number of target subcarriers in 1 RB, which may be configured by using CSI-RS-ResourceMapping->density;
(4) a location of a target subcarrier in each resource set of the first signal in an RB in which the target subcarrier is located, which may be configured by using CSI-RS-ResourceMapping->frequencyDomainAllocation;
(5) a frequency domain length occupied by each resource set of the first signal in frequency domain, which is configured by using CSI-frequencyOccupation->nrofRBs;
(6) beam ID: All resource sets belonging to a same first signal should be associated with a same beam, that is, there is a Type-D QCL relationship between all the resource sets, and may be configured by using tci-StatesToAddModList, each resource set may be configured as Type-D QCL, or each resource set and a same another signal (such as an SSB) may be configured as Type-D QCL; or
(7) resource set list: A list of IDs of all resource sets belonging to a same first signal, which is used to notify a receive end of the first signal which resource sets belong to the corresponding first signal.

In a sixth embodiment of this application, the chunk-wise uniform signal described in this application is considered to be used in both time domain and frequency domain.

If the first signal includes M resource sets in time domain and N resource sets in frequency domain, the first signal includes M×N resource sets in total. A configuration parameter of each resource set in time domain is the same as that in the fifth embodiment and a configuration parameter thereof in frequency domain is the same as that in the sixth embodiment.

In the foregoing solution in this embodiment of this application, resource configuration of the first signal can be implemented conveniently with reference to an existing reference signal, which significantly reduces overheads of a time domain resource of the first signal.

Optionally, the method in this embodiment of this application further includes:

The first device sends capability information, where the capability information is used to indicate whether the first device has a capability of processing the first signal that meets the first feature.

Optionally, the capability information is used to indicate whether the first device has a capability of performing a spectral analysis operation on a non-uniform signal sequence.

In this embodiment of this application, a receive end of the first signal needs to perform a spectral analysis operation on the non-uniform signal sequence by using the foregoing chunk-wise uniform signal. Therefore, in addition to conventional sensing capability information, the capability information herein further needs to include a spectral analysis operation capability of the non-uniform signal sequence. A typical algorithm for performing spectral analysis on the non-uniform signal sequence includes non-uniform fast Fourier transform (NUFFT), multiple signal classification (MUSIC), and the like.

If the first device does not have the capability of performing spectral analysis on the non-uniform signal sequence, the chunk-wise uniform signal described in this application cannot be used. Alternatively, the first device sends obtained data corresponding to the first signal to a sensing function network element (for example, a base station or a core network device), and the sensing function network element performs a spectral analysis operation on the non-uniform signal sequence. In this case, the first device is not required to have the capability of performing spectral analysis on the non-uniform signal sequence.

Optionally, the method in this embodiment of this application further includes:
performing a first operation on the first signal according to the parameter configuration information of the first signal, where the first operation includes at least one of sending, receiving, or signal processing.

Optionally, the method in this embodiment of this application further includes:

The first device obtains an activation instruction for the one or more resource sets, where the activation instruction is used to instruct the first device to perform a first operation on a first signal corresponding to the one or more resource sets, and the first operation includes at least one of sending, receiving, or signal processing.

Optionally, the activation signaling is obtained by using RRC signaling, a MAC CE, or DCI.

Optionally, the method in this embodiment of this application further includes:

The first device obtains a deactivation instruction for the one or more resource sets, where the deactivation instruction is used to instruct the first device to stop performing the first operation on the first signal corresponding to the at least one or more resource sets, and the first operation includes at least one of sending, receiving, or signal processing.

Optionally, the deactivation signaling is obtained by using RRC signaling, a MAC CE, or DCI.

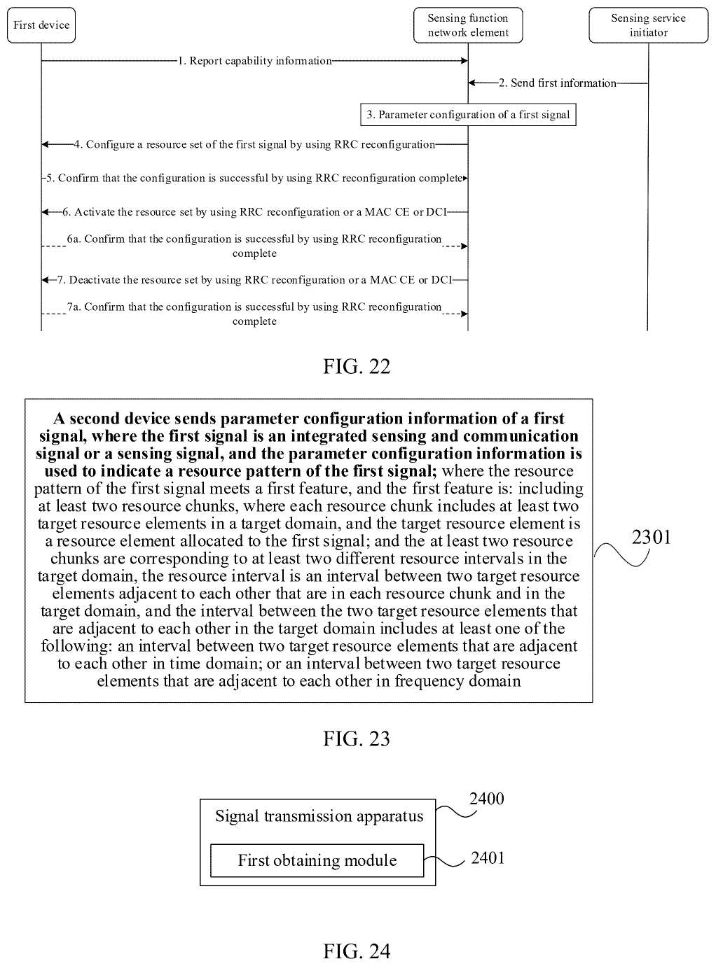

In an embodiment of this application, a CSI-RS is used as an example (which is also applicable to using another NR reference signal (for example, a DMRS or an SRS)). As shown in FIG. 22, the following steps may be specifically included:

Step 1: A first device (for example, a UE) reports capability information.

The capability information includes at least one of the following:
sensing capability information of the UE; or
whether the UE has a capability of performing a spectral analysis operation on a non-uniform signal sequence.

Step 2: A sensing function network element (for example, a base station or a core network device, where the sensing function network element is the foregoing second device) obtains first information from an initiator of a sensing service, where the first information includes at least one of the following:

A1: sensing prior information, including at least one of the following:
spatial range information of a sensing target region;
prior information of an empty location of a sensing object; or
motion parameter prior information of a sensing object, for example, a motion speed range and an acceleration range of the sensing object; and

A2: sensing requirement information, including at least one of the following:
(1) sensing service type: classified by type or specific to a service, such as imaging, positioning or track tracing, action identification, or distance measurement/speed measurement;
(2) sensing target region: a location region in which a sensing object may exist, or a location region in which imaging or environment reconstruction needs to be performed;
(3) sensing object type: classifying a sensing object according to a possible motion characteristic of the sensing object, where each sensing object type includes information such as a motion speed, a motion acceleration, and a typical RCS of a typical sensing object;
(4) sensing quality of service (QoS): a performance indicator for sensing a sensing target region or a sensing object, including at least one of the following:
a sensing resolution (which may be further divided into a distance/delay resolution, an angle resolution, a speed/Doppler resolution, and an imaging resolution), and the like;
a sensing precision (which may be further divided into a distance/delay precision, an angle precision, a speed/Doppler precision, a positioning precision, and the like);
a sensing range (which may be further divided into a distance/delay range, a speed/Doppler range, an angle range, an imaging range, and the like);
a sensing delay (a time interval from sending of a sensing signal to obtaining of a sensing result, or a time interval from initiating of a sensing requirement to obtaining of a sensing result);
a sensing update rate (a time interval between two consecutive times of performing sensing and obtaining sensing results);
a detection probability (a probability that a sensing object is correctly detected in a case that the sensing object exists);
a false alarm probability (a probability that a sensing object is incorrectly detected in a case that the sensing target does not exist); or
a maximum number of targets that can be sensed.

Step 3: The sensing function network element (that is, the foregoing second device, for example, a base station or a core network device) performs parameter configuration of the first signal according to the first information and with reference to the capability information of the first device, to obtain a configuration parameter of a resource set of the first signal that meets time domain features T1 to T5 and/or frequency domain feature F1 to F5.

It should be noted that the resource set of the first signal herein includes: a resource set included in the first signal when a sensing task is executed and a resource set included in the first signal after switching, where the latter may be not included.

Step 4: The sensing function network element (for example, a base station or a core network device) sends the configuration parameter of the resource set of the first signal to the first device (for example, the UE) by using RRC reconfiguration (RRCReconfiguration).

Step 4 may be implemented in the following manner:
sending the configuration parameter of the resource set of the first signal to the first device; and
notifying the first device of a type or an identifier of the configuration parameter of the resource set of the first signal, where configuration parameters of resource sets of the first signal that are of different types or identifiers may be agreed upon in a protocol, or may be notified in advance to the first device (for example, RRC signaling is used to indicate the configuration parameters of the first signal that are of different types or identifiers in a target domain, or layer 1 signaling, layer 2 signaling, or layer 1 and layer 2 combination signaling is used to indicate the configuration type or identifier of the first signal).

Step 5: The first device returns information to the sensing function network element by using RRC reconfiguration complete (RRCReconfigurationComplete), so as to confirm correct receiving of the configuration parameter of the resource set of the first signal.

Step 6: The sensing function network element sends activation instructions of all or a part of resource sets of the first signal to the first device by using RRC signaling, a MAC CE, or DCI, and the first device performs a first operation on the first signal.

The activation instruction is used to indicate at least one of the following:
indicating starting of a periodic (periodic), semipersistent (semipersistent), or aperiodic (aperiodic) resource set by using RRCReconfiguration configuration, where in this case, the first device needs to reply the sensing function network element with RRCReconfigurationComplete (step 6a in the figure); or indicating starting of a semipersistent resource set and/or one-time execution of an aperiodic resource set by using a MAC CE and/or DCI.

This process may be performed for a plurality of times, for example, activation of resource sets at a plurality of different time domain start locations is respectively performed with a plurality of pieces of signaling.

Step 7: The sensing function network element sends deactivation instructions of all or a part of the resource sets of the first signal to the first device by using RRC signaling, a MAC CE, or DCI, and the first device stops the first operation of all or a part of the resource sets.

The deactivation instruction is used to indicate at least one of the following:
indicating ending of a periodic resource set by using RRCReconfiguration configuration, where in this case, the first device needs to reply the sensing function network element with RRCReconfigurationComplete (step 7a in the figure); or
indicating ending of a semipersistent resource set by using a MAC CE and/or DCI.

This process may be performed for a plurality of times, for example, deactivation of resource sets at a plurality of different time domain end locations is respectively performed with a plurality of pieces of signaling.

According to the method in this embodiment of this application, resource overheads of a sensing signal can be greatly reduced while sensing resolution performance and maximum unambiguous measurement range performance are met. In addition, the method in this embodiment of this application can conveniently implement configuration of a sensing signal with reference to an existing reference signal, thereby further reducing resource overheads.

As shown in FIG. 23, an embodiment of this application further provides a signal transmission method, including:

Step 2301: A second device sends parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

In this step, the second device sends the parameter configuration information of the first signal to a first device, where the first device includes but is not limited to a terminal or a base station, and the second device includes but is not limited to a base station or a core network device.

In this embodiment of this application, a second device sends parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

It should be noted that the parameter configuration information of the first signal that is sent by the second device side is the same as the parameter configuration information of the first signal that is obtained by the first device, and the parameter configuration information of the first signal has been described in detail in the foregoing method embodiment of the first device side. Details are not described herein again.

Optionally, the method further includes:

The second device obtains capability information sent by a first device, where the capability information is used to indicate whether the first device has a capability of processing the first signal that meets the first feature.

Optionally, the capability information is used to indicate whether the first device has a capability of performing a spectral analysis operation on a non-uniform signal sequence.

Optionally, the parameter configuration information includes resource configuration information of one or more resource sets, each resource set includes at least one target resource element, and the one or more resource sets are used to constitute the at least two resource chunks.

Optionally, the method in this embodiment of this application further includes:

The second device sends an activation instruction for the one or more resource sets, where the activation instruction is used to instruct the first device to perform a first operation on a first signal corresponding to the one or more resource sets, and the first operation includes at least one of sending, receiving, or signal processing.

Optionally, the method in this embodiment of this application further includes:

The second device sends a deactivation instruction for the one or more resource sets, where the deactivation instruction is used to instruct the first device to stop performing the first operation on the first signal corresponding to the at least one or more resource sets, and the first operation includes at least one of sending, receiving, or signal processing.

Optionally, the method in this embodiment of this application further includes:

The second device performs a first operation on the first signal according to the parameter configuration information of the first signal, where the first operation includes at least one of sending, receiving, or signal processing.

It should be noted that an interaction process between the second device and the first device has been described in detail in the foregoing method embodiment of the first device side. Details are not described herein again.

In this embodiment of this application, a second device sends parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

The signal transmission method provided in embodiments of this application may be performed by a signal transmission apparatus. In embodiments of this application, the signal transmission apparatus provided in embodiments of this application is described by using an example in which the signal transmission apparatus performs the signal transmission method.

As shown in FIG. 24, an embodiment of this application further provides a signal transmission apparatus 2400, applied to a first device and including:
a first obtaining module 2401, configured to receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

Optionally, in a case that the target domain includes time domain, the at least two resource chunks include M time domain resource chunks, M>2, and M is a positive integer;
in a case that the target domain includes frequency domain, the at least two resource chunks include N frequency domain resource chunks, N>2, and N is a positive integer; and
in a case that the target domain includes time domain and frequency domain, the at least two resource chunks include M×N time-frequency domain resource chunks, and the M×N time-frequency domain resource chunks are determined according to M time domain resource chunks and N frequency domain resource chunks.

Optionally, the at least two resource chunks meet at least one of the following:
the at least two target resource elements that are in each resource chunk and in the target domain are uniformly distributed in the target domain;
a resource span of the at least two resource chunks in the target domain meets a resolution requirement of a sensing measurement amount corresponding to the target domain; or
a resource interval of at least one resource chunk in the target domain meets a maximum unambiguous measurement range requirement of the sensing measurement amount corresponding to the target domain;
where the resource span is a span between the first target resource element and the last target resource element of the at least two resource chunks in the target domain, and the sensing measurement amount corresponding to the target domain includes Doppler, speed, delay, or distance.

Optionally, the target domain includes time domain, and a resource span of the at least two resource chunks in time domain meets a resolution requirement of the Doppler or the speed.

Optionally, the target domain includes time domain, and a resource interval of the at least one resource chunk in time domain meets a maximum unambiguous measurement range requirement of the Doppler or the speed.

Optionally, the target domain includes frequency domain, and a resource span of the at least two resource chunks in frequency domain meets a resolution requirement of the delay or the distance.

Optionally, the target domain includes frequency domain, and a resource interval of the at least one resource chunk in frequency domain meets a maximum unambiguous measurement range requirement of the delay or the distance.

Optionally, the parameter configuration information includes resource configuration information of one or more resource sets, each resource set includes at least one target resource element, and the at least two resource chunks include the one or more resource sets.

Optionally, a mapping relationship between the at least two resource chunks and the one or more resource sets meets at least one of the following:
at least one resource chunk is in a one-to-one correspondence with at least one resource set; or
at least one resource chunk is corresponding to at least two resource sets.

Optionally, the resource configuration information of the one or more resource sets includes at least one of the following:
a start location of the one or more resource sets in the target domain;
a span of the one or more resource sets in the target domain;
a resource interval between target resource elements in the one or more resource sets;
a number of target resource elements in the one or more resource sets;
a density of target resource elements in the one or more resource sets;
a repetition period, in time domain, of a slot in which a target resource element in the one or more resource sets is located;
a location of a target resource element in the one or more resource sets in a slot in which the target resource element is located;
a repetition period, in frequency domain, of a resource block RB in which a target resource element in the one or more resource sets is located;
a location, in frequency domain, of an RB in which a target resource element in the one or more resource sets is located;
a location of a target resource element in the one or more resource sets in an RB in which the target resource element is located; or
first indication information, where the first indication information is used to indicate that the target domain is time domain and/or frequency domain;
where the span of the resource set in the target domain is a span between the first resource element and the last resource element of the resource set in the target domain.

Optionally, the parameter configuration information further includes at least one of the following:
a start location of the first signal in the target domain;
a resource span of the first signal in the target domain; or
a repetition period of the first signal in time domain;
where the resource span of the first signal in the target domain is a span between the first target resource element and the last target resource element of the at least two resource chunks in the target domain.

Optionally, the first signal is configured as single-port or multi-port; and
in a case that the first signal is configured as multi-port, resources of first signals of different ports meet at least one of the following:
frequency division multiplexing;
time division multiplexing;
resource patterns of the first signals of the different ports in the target domain are the same, and generation sequences used for the first signals of the different ports are different; or resource patterns of the first signals of the different ports in the target domain are the same, generation sequences used for the first signals of the different ports are the same, and orthogonal covering codes corresponding to different first signals are different.

Optionally, the apparatus 2400 further includes:

A second transceiver module, configured to send capability information, where the capability information is used to indicate whether the first device has a capability of processing the first signal that meets the first feature.

Optionally, the apparatus 2400 further includes:
a first execution module, configured to perform a first operation on the first signal according to the parameter configuration information of the first signal, where the first operation includes at least one of sending, receiving, or signal processing.

Optionally, the apparatus 2400 further includes:
a second obtaining module, configured to obtain an activation instruction for the one or more resource sets, where the activation instruction is used to instruct the first device to perform a first operation on a first signal corresponding to the one or more resource sets, and the first operation includes at least one of sending, receiving, or signal processing.

Optionally, the apparatus 2400 further includes:
a third obtaining module, configured to obtain a deactivation instruction for the one or more resource sets, where the deactivation instruction is used to instruct the first device to stop performing the first operation on the first signal corresponding to the at least one or more resource sets, and the first operation includes at least one of sending, receiving, or signal processing. In embodiments of this application, a first device receives parameter configuration

information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

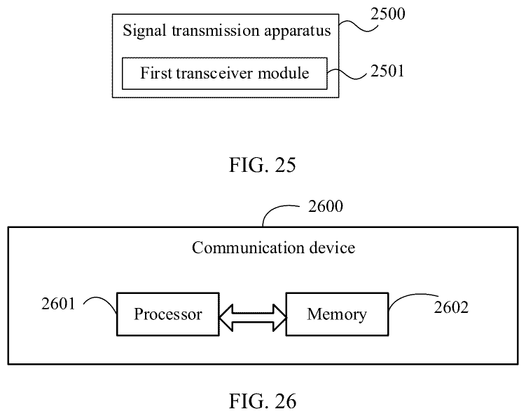

As shown in FIG. 25, an embodiment of this application further provides a signal transmission apparatus 2500, applied to a second device and including:
a first transceiver module 2501, configured to send parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

Optionally, the apparatus 2500 in this embodiment of this application further includes:
a fourth obtaining module, configured to obtain capability information sent by a first device, where the capability information is used to indicate whether the first device has a capability of processing the first signal that meets the first feature.

Optionally, the apparatus 2500 in this embodiment of this application further includes:
a second execution module, configured to perform a first operation on the first signal according to the parameter configuration information of the first signal, where the first operation includes at least one of sending, receiving, or signal processing.

Optionally, according to the apparatus 2500 in this embodiment of this application, the parameter configuration information includes resource configuration information of one or more resource sets, each resource set includes at least one target resource element, and the one or more resource sets are used to constitute the at least two resource chunks.

Optionally, the apparatus 2500 in this embodiment of this application further includes:
a third transceiver module, configured to send an activation instruction for the one or more resource sets, where the activation instruction is used to instruct the first device to perform a first operation on a first signal corresponding to the one or more resource sets, and the first operation includes at least one of sending, receiving, or signal processing.

Optionally, the apparatus 2500 in this embodiment of this application further includes:
a fourth transceiver module, configured to send a deactivation instruction for the one or more resource sets, where the deactivation instruction is used to instruct the first device to stop performing the first operation on the first signal corresponding to the at least one or more resource sets, and the first operation includes at least one of sending, receiving, or signal processing.

In this embodiment of this application, a second device sends parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

The signal transmission apparatus in embodiments of this application may be an electronic device, for example, an electronic device with an operating system; or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a network attached storage (NAS), or the like. This is not specifically limited in embodiments of this application.

The signal transmission apparatus provided in this embodiment of this application can implement the processes implemented in the method embodiments of FIG. 2 to FIG. 23, and achieve the same technical effects. To avoid repetition, details are not described herein again.

Optionally, as shown in FIG. 26, an embodiment of this application further provides a communication device 2600, including a processor 2601 and a memory 2602. The memory 2602 stores a program or instructions capable of running on the processor 2601. For example, when the communication device 2600 is a terminal, the program or the instructions are executed by the processor 2601 to implement the steps in the signal transmission method embodiment executed by the first device, and the same technical effects can be achieved. When the communication device 2600 is a network-side device, and the program or the instructions are executed by the processor 2601, the steps in the signal transmission method embodiment executed by the first device or the second device are implemented, and the same technical effects can be achieved. To avoid repetition, details are not described herein again.

An embodiment of this application further provides a terminal, including a processor and a communication interface, where the communication interface is configured to receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain. The terminal embodiment corresponds to the foregoing method embodiment on the first device side. Each implementation process and implementation of the foregoing method embodiment may be applied to the terminal embodiment, and the same technical effects can be achieved.

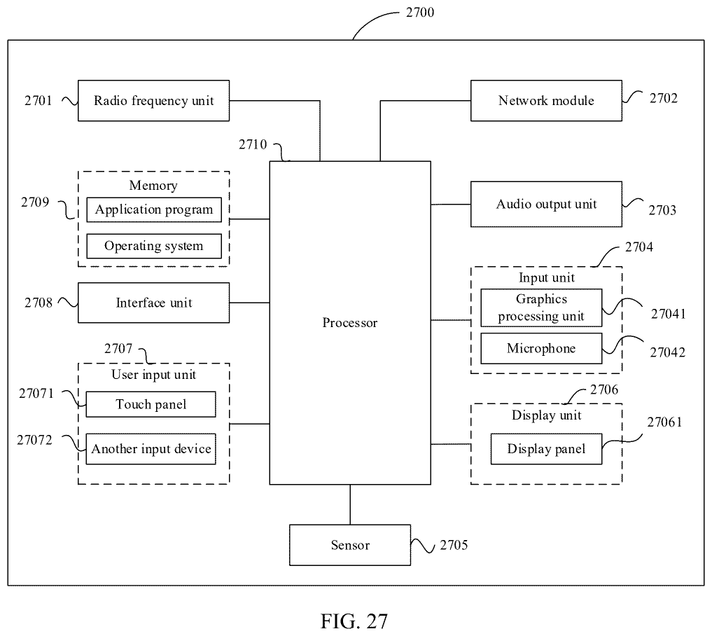

Specifically, FIG. 27 is a schematic structural diagram of hardware of a terminal for implementing an embodiment of this application.

The terminal 2700 includes but is not limited to at least some components of a radio frequency unit 2701, a network module 2702, an audio output unit 2703, an input unit 2704, a sensor 2705, a display unit 2706, a user input unit 2707, an interface unit 2708, a memory 2709, a processor 2710, and the like.

A person skilled in the art may understand that the terminal 2700 may further include a power supply (for example, a battery) that supplies power to each component. The power supply may be logically connected to the processor 2710 by using a power management system, to implement functions such as charging management, discharging management, and power consumption management through the power management system. The structure of the terminal shown in FIG. 27 does not constitute a limitation on the terminal. The terminal may include more or fewer components than those shown in the figure, or combine some components, or have different component arrangements. Details are not described herein again.

It should be understood that in this embodiment of this application, the input unit 2704 may include a graphics processing unit (GPU) 27041 and a microphone 27042, and the graphics processing unit 27041 processes image data of a still picture or a video obtained by an image capture apparatus (for example, a camera) in a video capture mode or an image capture mode. The display unit 2706 may include a display panel 27061, and the display panel 27061 may be configured in a form of a liquid crystal display, an organic light-emitting diode, or the like. The user input unit 2707 includes at least one of a touch panel 27071 or another input device 27072. The touch panel 27071 is also referred to as a touchscreen. The touch panel 27071 may include two parts: a touch detection apparatus and a touch controller. The another input device 27072 may include but is not limited to a physical keyboard, a function key (such as a volume control key or an on/off key), a trackball, a mouse, and an operating lever. Details are not described herein again.

In this embodiment of this application, after receiving downlink data from a network-side device, the radio frequency unit 2701 may transmit the downlink data to the processor 2710 for processing. In addition, the radio frequency unit 2701 may send uplink data to a network-side device. Generally, the radio frequency unit 2701 includes but is not limited to an antenna, an amplifier, a transceiver, a coupler, a low-noise amplifier, a duplexer, and the like.

The memory 2709 may be configured to store a software program or instructions and various types of data. The memory 2709 may mainly include a first storage area for storing a program or instructions and a second storage area for storing data. The first storage area may store an operating system, an application program or instructions required by at least one function (for example, a sound play function or an image play function), and the like. In addition, the memory 2709 may include a volatile memory or a non-volatile memory, or the memory 2709 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 2709 in this embodiment of this application includes but is not limited to these memories and any other suitable type of memory.

The processor 2710 may include one or more processing units. Optionally, the processor 2710 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 2710.

The radio frequency unit 2701 is configured to receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain.

Optionally, in a case that the target domain includes time domain, the at least two resource chunks include M time domain resource chunks, M>2, and M is a positive integer;
in a case that the target domain includes frequency domain, the at least two resource chunks include N frequency domain resource chunks, N>2, and N is a positive integer; and
in a case that the target domain includes time domain and frequency domain, the at least two resource chunks include M×N time-frequency domain resource chunks, and the M×N time-frequency domain resource chunks are determined according to M time domain resource chunks and N frequency domain resource chunks.

Optionally, the at least two resource chunks meet at least one of the following:
the at least two target resource elements that are in each resource chunk and in the target domain are uniformly distributed in the target domain;
a resource span of the at least two resource chunks in the target domain meets a resolution requirement of a sensing measurement amount corresponding to the target domain; or
a resource interval of at least one resource chunk in the target domain meets a maximum unambiguous measurement range requirement of the sensing measurement amount corresponding to the target domain;
where the resource span is a span between the first target resource element and the last target resource element of the at least two resource chunks in the target domain, and the sensing measurement amount corresponding to the target domain includes Doppler, speed, delay, or distance.

Optionally, the target domain includes time domain, and a resource span of the at least two resource chunks in time domain meets a resolution requirement of the Doppler or the speed.

Optionally, the target domain includes time domain, and a resource interval of the at least one resource chunk in time domain meets a maximum unambiguous measurement range requirement of the Doppler or the speed.

Optionally, the target domain includes frequency domain, and a resource span of the at least two resource chunks in frequency domain meets a resolution requirement of the delay or the distance.

Optionally, the target domain includes frequency domain, and a resource interval of the

at least one resource chunk in frequency domain meets a maximum unambiguous measurement range requirement of the delay or the distance.

Optionally, the parameter configuration information includes resource configuration information of one or more resource sets, each resource set includes at least one target resource element, and the at least two resource chunks include the one or more resource sets.

Optionally, a mapping relationship between the at least two resource chunks and the one or more resource sets meets at least one of the following:
at least one resource chunk is in a one-to-one correspondence with at least one resource set; or
at least one resource chunk is corresponding to at least two resource sets.

Optionally, the resource configuration information of the one or more resource sets includes at least one of the following:
a start location of the one or more resource sets in the target domain;
a span of the one or more resource sets in the target domain;
a resource interval between target resource elements in the one or more resource sets;
a number of target resource elements in the one or more resource sets;
a density of target resource elements in the one or more resource sets;
a repetition period, in time domain, of a slot in which a target resource element in the one or more resource sets is located;
a location of a target resource element in the one or more resource sets in a slot in which the target resource element is located;
a repetition period, in frequency domain, of a resource block RB in which a target resource element in the one or more resource sets is located;
a location, in frequency domain, of an RB in which a target resource element in the one or more resource sets is located;
a location of a target resource element in the one or more resource sets in an RB in which the target resource element is located; or
first indication information, where the first indication information is used to indicate that the target domain is time domain and/or frequency domain;
where the span of the resource set in the target domain is a span between the first resource element and the last resource element of the resource set in the target domain.

Optionally, the parameter configuration information further includes at least one of the following:
a start location of the first signal in the target domain;
a resource span of the first signal in the target domain; or
a repetition period of the first signal in time domain;
where the resource span of the first signal in the target domain is a span between the first target resource element and the last target resource element of the at least two resource chunks in the target domain.

Optionally, the first signal is configured as single-port or multi-port; and
in a case that the first signal is configured as multi-port, resources of first signals of different ports meet at least one of the following:
frequency division multiplexing;
time division multiplexing;
resource patterns of the first signals of the different ports in the target domain are the same, and generation sequences used for the first signals of the different ports are different; or resource patterns of the first signals of the different ports in the target domain are the same, generation sequences used for the first signals of the different ports are the same, and orthogonal covering codes corresponding to different first signals are different.

Optionally, the radio frequency unit 2701 is further configured to perform a first operation on the first signal according to the parameter configuration information of the first signal, where the first operation includes at least one of sending, receiving, or signal processing.

Optionally, the radio frequency unit 2701 is further configured to:
send capability information, where the capability information is used to indicate whether the first device has a capability of processing the first signal that meets the first feature.

Optionally, the radio frequency unit 2701 is further configured to:
obtain an activation instruction for the one or more resource sets, where the activation instruction is used to instruct the first device to perform a first operation on a first signal corresponding to the one or more resource sets, and the first operation includes at least one of sending, receiving, or processing.

Optionally, the radio frequency unit 2701 is further configured to:
obtain a deactivation instruction for the one or more resource sets, where the deactivation instruction is used to instruct the first device to stop performing the first operation on the first signal corresponding to the at least one or more resource sets, and the first operation includes at least one of sending, receiving, or processing.

In embodiments of this application, a first device receives parameter configuration information of a first signal, where the first signal is an integrated sensing and communication signal or a sensing signal, and the parameter configuration information is used to indicate a resource pattern of the first signal; the resource pattern of the first signal meets a first feature, and the first feature is: including at least two resource chunks, where each resource chunk includes at least two target resource elements in a target domain, and the target resource element is a resource element allocated to the first signal; and the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain. Because the at least two resource chunks are corresponding to different resource intervals in the target domain, in an integrated sensing and communication scenario, a resource interval between some resource chunks in the target domain may be set according to a sensing requirement as a resource interval that meets a resolution requirement of a corresponding sensing measurement amount, and a relatively large resource interval may be set for another resource chunk in the target domain, so that resource overheads can be reduced when the first signal can meet the sensing requirement.

An embodiment of this application further provides a network-side device, including a processor and a communication interface, where the communication interface is configured to send or receive parameter configuration information of a first signal, where the first signal is an integrated sensing and communication signal or a sensing signal, and the parameter configuration information is used to indicate a resource pattern of the first signal;
where the resource pattern of the first signal meets a first feature, and the first feature is:
including at least two resource chunks, where each resource chunk includes at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain includes at least one of the following: an interval between two target resource elements that are adjacent to each other in time domain; or an interval between two target resource elements that are adjacent to each other in frequency domain;
where the target domain includes at least one of time domain or frequency domain. The network-side device embodiment corresponds to the foregoing method embodiment on the second device side. Each implementation process and implementation of the foregoing method embodiment may be applied to the network-side device embodiment, and the same technical effects can be achieved.

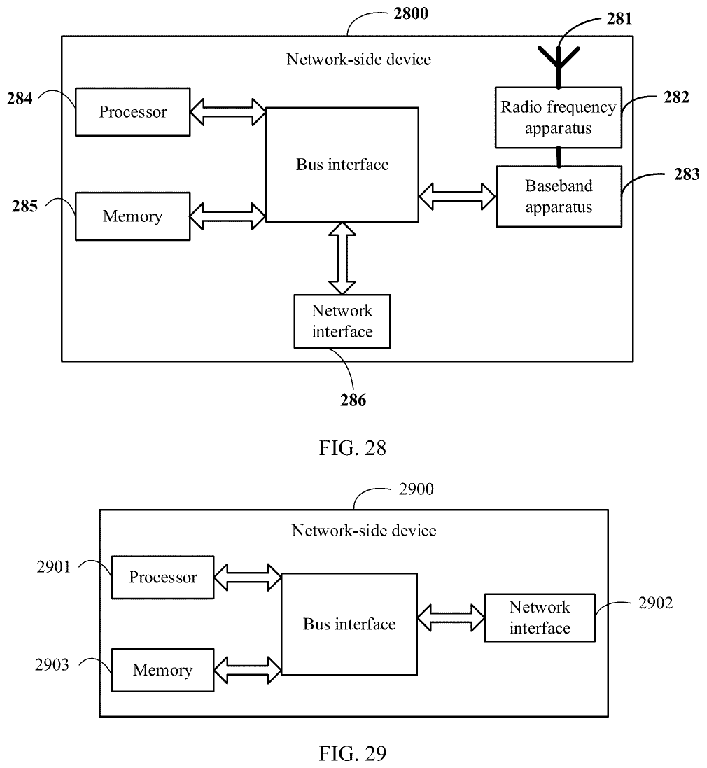

Specifically, an embodiment of this application further provides a network-side device. As shown in FIG. 28, the network-side device 2800 includes an antenna 281, a radio frequency apparatus 282, a baseband apparatus 283, a processor 284, and a memory 285. The antenna 281 is connected to the radio frequency apparatus 282. In an uplink direction, the radio frequency apparatus 282 receives information through the antenna 281, and sends the received information to the baseband apparatus 283 for processing. In a downlink direction, the baseband apparatus 283 processes to-be-sent information, and sends processed information to the radio frequency apparatus 282. After processing the received information, the radio frequency apparatus 282 sends processed information through the antenna 281.

The method performed by the first device or the second device in the foregoing embodiment may be implemented in the baseband apparatus 283, and the baseband apparatus 283 includes a baseband processor.

For example, the baseband apparatus 283 may include at least one baseband board. A plurality of chips are disposed on the baseband board. As shown in FIG. 28, one of the chips is, for example, a baseband processor, and is connected to the memory 285 by using a bus interface, to invoke a program in the memory 285 to perform the operation of the first device or the second device shown in the foregoing method embodiment.

The network-side device may further include a network interface 286. For example, the interface is a common public radio interface (CPRI).

Specifically, the network-side device 2800 in this embodiment of this application further includes instructions or a program stored in the memory 285 and capable of running on the processor 284. The processor 284 invokes the instructions or the program in the memory 285 to perform the method performed by the modules shown in FIG. 25, and the same technical effects are achieved. To avoid repetition, details are not described herein again.

Specifically, an embodiment of this application further provides a network-side device. As shown in FIG. 29, the network-side device 2900 includes a processor 2901, a network interface 2902, and a memory 2903. The network interface 2902 is, for example, a common public radio interface (CPRI).

Specifically, the network-side device 2900 in this embodiment of this application further includes instructions or a program that is stored in the memory 2903 and that is capable of running on the processor 2901. The processor 2901 invokes the instructions or the program in the memory 2903 to perform the method performed by the modules shown in FIG. 24 or FIG. 25, and the same technical effects are achieved. To avoid repetition, details are not described herein again.

An embodiment of this application further provides a readable storage medium. The readable storage medium stores a program or instructions. The program or the instructions are executed by a processor to implement the processes in the foregoing signal transmission method embodiments, and the same technical effects can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing signal transmission method embodiments, and the same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing signal transmission method embodiments, and the same technical effects can be achieved. To avoid repetition, details are not described herein again.

An embodiment of this application further provides a signal transmission system, including a first device and a second device, where the first device may be configured to perform the steps of the signal transmission method performed by the first device, and the second device may be configured to perform the steps of the signal transmission method performed by the second device.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A signal transmission method, comprising:
receiving, by a first device, parameter configuration information of a first signal, wherein the first signal is an integrated sensing and communication signal or a sensing signal, and the parameter configuration information is used to indicate a resource pattern of the first signal;
wherein the resource pattern of the first signal meets a first feature, and the first feature is:
comprising at least two resource chunks, wherein each resource chunk comprises at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain comprises at least one of the following: an interval between two target resource elements that are adjacent to each other in time domain; or an interval between two target resource elements that are adjacent to each other in frequency domain;
wherein the target domain comprises at least one of time domain or frequency domain.

2. The method according to claim 1, wherein
in a case that the target domain comprises time domain, the at least two resource chunks comprise M time domain resource chunks, M≥2, and M is a positive integer;
in a case that the target domain comprises frequency domain, the at least two resource chunks comprise N frequency domain resource chunks, N≥2, and N is a positive integer; and
in a case that the target domain comprises time domain and frequency domain, the at least two resource chunks comprise M×N time-frequency domain resource chunks, and the M×N time-frequency domain resource chunks are determined according to M time domain resource chunks and N frequency domain resource chunks.

3. The method according to claim 1, wherein the at least two resource chunks meet at least one of the following:
the at least two target resource elements that are in each resource chunk and in the target domain are uniformly distributed in the target domain;
a resource span of the at least two resource chunks in the target domain meets a resolution requirement of a sensing measurement amount corresponding to the target domain; or
a resource interval of at least one resource chunk in the target domain meets a maximum unambiguous measurement range requirement of the sensing measurement amount corresponding to the target domain;
wherein the resource span is a span between the first target resource element and the last target resource element of the at least two resource chunks in the target domain, and the sensing measurement amount corresponding to the target domain comprises Doppler, speed, delay, or distance.

4. The method according to claim 3, wherein the target domain comprises time domain, and a resource span of the at least two resource chunks in time domain meets a resolution requirement of the Doppler or the speed,
or wherein the target domain comprises time domain, and a resource interval of the at least one resource chunk in time domain meets a maximum unambiguous measurement range requirement of the Doppler or the speed,
or wherein the target domain comprises frequency domain, and a resource span of the at least two resource chunks in frequency domain meets a resolution requirement of the delay or the distance,
or wherein the target domain comprises frequency domain, and a resource interval of the at least one resource chunk in frequency domain meets a maximum unambiguous measurement range requirement of the delay or the distance.

5. The method according to claim 1, wherein the parameter configuration information comprises resource configuration information of one or more resource sets, each resource set comprises at least one target resource element, and the at least two resource chunks comprise the one or more resource sets.

6. The method according to claim 5, wherein a mapping relationship between the at least two resource chunks and the one or more resource sets meets at least one of the following:
at least one resource chunk is in a one-to-one correspondence with at least one resource set; or
at least one resource chunk is corresponding to at least two resource sets,
or wherein the resource configuration information of the one or more resource sets comprises at least one of the following:
a start location of the one or more resource sets in the target domain;
a span of the one or more resource sets in the target domain;
a resource interval between target resource elements in the one or more resource sets;
a number of target resource elements in the one or more resource sets;
a density of target resource elements in the one or more resource sets;
a repetition period, in time domain, of a slot in which a target resource element in the one or more resource sets is located;
a location of a target resource element in the one or more resource sets in a slot in which the target resource element is located;
a repetition period, in frequency domain, of a resource block RB in which a target resource element in the one or more resource sets is located;
a location, in frequency domain, of an RB in which a target resource element in the one or more resource sets is located;
a location of a target resource element in the one or more resource sets in an RB in which the target resource element is located; or
first indication information, wherein the first indication information is used to indicate that the target domain is time domain and/or frequency domain;
wherein the span of the resource set in the target domain is a span between the first resource element and the last resource element of the resource set in the target domain.

7. The method according to claim 5, wherein the parameter configuration information further comprises at least one of the following:
a start location of the first signal in the target domain;
a resource span of the first signal in the target domain; or
a repetition period of the first signal in time domain;
wherein the resource span of the first signal in the target domain is a span between the first target resource element and the last target resource element of the at least two resource chunks in the target domain.

8. The method according to claim 5, wherein the method further comprises at least one of the following:
obtaining, by the first device, an activation instruction for the one or more resource sets, wherein the activation instruction is used to instruct the first device to perform a first operation on a first signal corresponding to the one or more resource sets, and the first operation comprises at least one of sending, receiving, or signal processing; or
obtaining, by the first device, a deactivation instruction for the one or more resource sets, wherein the deactivation instruction is used to instruct the first device to stop performing the first operation on the first signal corresponding to the at least one or more resource sets, and the first operation comprises at least one of sending, receiving, or signal processing.

9. The method according to claim 1, wherein the first signal is configured as single-port or multi-port; and
in a case that the first signal is configured as multi-port, resources of first signals of different ports meet at least one of the following:
frequency division multiplexing;
time division multiplexing;
resource patterns of the first signals of the different ports in the target domain are the same, and generation sequences used for the first signals of the different ports are different; or resource patterns of the first signals of the different ports in the target domain are the same, generation sequences used for the first signals of the different ports are the same, and orthogonal covering codes corresponding to different first signals are different.

10. The method according to claim 1, wherein the method further comprises:
sending, by the first device, capability information, wherein the capability information is used to indicate whether the first device has a capability of processing the first signal that meets the first feature.

11. The method according to claim 1, further comprising:
performing the first operation on the first signal according to the parameter configuration information of the first signal, wherein the first operation comprises at least one of sending, receiving, or signal processing.

12. A signal transmission method, comprising:
sending, by a second device, parameter configuration information of a first signal, wherein the first signal is an integrated sensing and communication signal or a sensing signal, and the parameter configuration information is used to indicate a resource pattern of the first signal;
wherein the resource pattern of the first signal meets a first feature, and the first feature is:
comprising at least two resource chunks, wherein each resource chunk comprises at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain comprises at least one of the following: an interval between two target resource elements that are adjacent to each other in time domain; or an interval between two target resource elements that are adjacent to each other in frequency domain;
wherein the target domain comprises at least one of time domain or frequency domain.

13. The method according to claim 12, further comprising:
obtaining, by the second device, capability information sent by a first device, wherein the capability information is used to indicate whether the first device has a capability of processing the first signal that meets the first feature.

14. The method according to claim 12, wherein the parameter configuration information comprises resource configuration information of one or more resource sets, each resource set comprises at least one target resource element, and the one or more resource sets are used to constitute the at least two resource chunks.

15. The method according to claim 12, further comprising:
performing a first operation on the first signal according to the parameter configuration information of the first signal, wherein the first operation comprises at least one of sending, receiving, or signal processing.

16. The method according to claim 12, wherein the method further comprises:
sending, by the second device, an activation instruction for the one or more resource sets, wherein the activation instruction is used to instruct the first device to perform a first operation on a first signal corresponding to the one or more resource sets, and the first operation comprises at least one of sending, receiving, or processing.

17. The method according to claim 14, further comprising:
sending, by the second device, a deactivation instruction for the one or more resource sets, wherein the deactivation instruction is used to instruct the first device to stop performing the first operation on the first signal corresponding to the at least one or more resource sets, and the first operation comprises at least one of sending, receiving, or processing.

18. A communication device, comprising a processor and a memory, wherein the memory stores a program or instructions capable of running on the processor, and when the program or the instructions are executed by the processor, a signal transmission method is implemented,
wherein the signal transmission method comprises:
receiving, by the communication device, parameter configuration information of a first signal, or sending, by the communication device, the parameter configuration information of the first signal, wherein the first signal is an integrated sensing and communication signal or a sensing signal, and the parameter configuration information is used to indicate a resource pattern of the first signal;
wherein the resource pattern of the first signal meets a first feature, and the first feature is:
comprising at least two resource chunks, wherein each resource chunk comprises at least two target resource elements in a target domain, and the target resource element is a resource element allocated to the first signal; and
the at least two resource chunks are corresponding to at least two different resource intervals in the target domain, the resource interval is an interval between two target resource elements adjacent to each other that are in each resource chunk and in the target domain, and the interval between the two target resource elements that are adjacent to each other in the target domain comprises at least one of the following: an interval between two target resource elements that are adjacent to each other in time domain; or an interval between two target resource elements that are adjacent to each other in frequency domain.

19. A non-transitory readable storage medium, wherein the non-transitory readable storage medium stores a program or instructions, and when the program or the instructions are executed by a processor, the steps of the signal transmission method according to claim 1.

20. A non-transitory readable storage medium, wherein the non-transitory readable storage medium stores a program or instructions, and when the program or the instructions are executed by a processor, the steps of the signal transmission method according to claim 12.
